(19) United States
(12) Patent Application Publication
(10) Pub. No.: US 2011/0156907 A1
(43) Pub. Date: Jun. 30, 2011

(54) APPARATUS FOR COMMUNICATING WITH RFID TAG AND SYSTEM FOR ARTICLE MANAGEMENT

(75) Inventor: Takuya NAGAI, Nagoya-shi (JP)

(73) Assignee: BROTHER KOGYO KABUSHIKI KAISHA, Nagoya-shi (JP)

(21) Appl. No.: 13/040,616

(22) Filed: Mar. 4, 2011

Related U.S. Application Data
(63) Continuation-in-part of application No. PCT/JP2009/056259, filed on Mar. 27, 2009.

(30) Foreign Application Priority Data
Sep. 30, 2008 (JP) 2008-255546

(51) Int. Cl. G08B 13/14

(52) U.S. Cl. 340/572.1

(57) ABSTRACT

This disclosure discloses an apparatus for communicating with a radio frequency identification (RFID) tag, comprising: an apparatus antenna device configured to perform radio communication with a plurality of RFID tag circuit elements including a first RFID tag circuit element and a second RFID tag circuit element; a power control portion; an information obtaining portion configured to obtain information from the first RFID tag circuit element and the second RFID tag circuit element, based on the power controlled by the power control portion; and an association processing portion configured to perform the association processing of tag identification information of the second RFID tag circuit element with tag identification information of the first RFID tag circuit element.

### CROSS-REFERENCE TO RELATED APPLICATION

This is a CIP application PCT/JP2009/056259, filed Mar. 27, 2009, which was not published under PCT article 21(2) in English.

### BACKGROUND OF THE INVENTION

1. Field of the Invention

The present invention relates to an apparatus for communicating with a radio frequency identification (RFID) tag configured to perform article management by reading information held by an RFID tag disposed on an article as an object of management, and a system for article management, the system having the apparatus.

2. Description of the Related Art

There are already known RFID systems that perform article management by disposing an RFID tag on an article as a target object of management and contactlessly reading information that is held by the RFID tag.

As prior art references related to article management by such an RFID system, there is a system for article management. In this system, an apparatus for communicating with an RFID tag, namely a reader, detects movement of an RFID tag circuit element for an article disposed on an article that is a target object of management through radio communication. When, based on a result of the detection, an unclear state has occurred in terms of article management, a camera device operates, based on control by a management server. Then, the camera device captures the image of a desired portion to collect security information, or a buzz sounds to notify security information. As a result, security of article management can be improved.

In the above described prior art, it is necessary to register in a database in advance respective positions where articles as target objects of management are to be present, and an authorized person having the authority to move the articles, in other words, a person having the authority to take out or return the articles. It is necessary to perform associating of the articles and the person through input by an operator, which requires efforts. Further, in article management after registration, first, an apparatus for communicating with an RFID tag detects whether or not an RFID tag circuit element for an article has moved from a position where the RFID tag circuit element is to be present. When it is detected that the RFID tag circuit element for an article has moved, the apparatus for communicating with an RFID tag detects an RFID tag circuit element for a person and inquires the database whether the combination with the RFID tag circuit element for a person is correct. That is, in the above described prior art, before making an inquiry with association between the article and the person, it is necessary for the apparatus for communicating with an RFID tag to detect the position of the RFID tag circuit element for the article. Further, the detection of the position by the apparatus for communicating with an RFID tag is performed under complicated control, such as phased array control.

As has been described above, in the above-described prior art, reliable associating of an article and a person to each other by simple control has not been considered for registration into a database nor for article management after registration.

An object of the present invention is to provide an apparatus for communicating with an RFID tag and a system for article management that reliably associate an article and a person with each other by simple control and enables management of taking out and returning articles with high accuracy.

### SUMMARY OF THE INVENTION

In order to achieve the above-mentioned object, according to the invention, there is provided an apparatus for communicating with a radio frequency identification (RFID) tag, comprising: an apparatus antenna device configured to perform radio communication with a plurality of RFID tag circuit elements, the RFID circuit elements each having an IC circuit part configured to store information and a tag antenna capable of transmission and reception of information, and including a first RFID tag circuit element and a second RFID tag circuit element; a power control portion capable of changing power of the apparatus antenna device; an information obtaining portion configured to obtain information via the apparatus antenna device from the first RFID tag circuit element to be a reference for association processing and the second RFID tag circuit element being an object of association with the first RFID tag circuit element, based on the power controlled by the power control portion; and an association processing portion configured to perform the association processing of tag identification information of the second RFID tag circuit element with tag identification information of the first RFID tag circuit element, based on a result of comparison between a power value of the apparatus antenna device when the information obtaining portion has obtained information from the second RFID tag circuit element and a power value of the apparatus antenna device when the information obtaining portion has obtained information from the first RFID tag circuit element.

In order to achieve the above-mentioned object, according to the invention, there is provided a system for article management, comprising: a third RFID tag circuit element that has an IC circuit part configured to store information and a tag antenna capable of transmission and reception of information, and is held or accompanied by a person; a fourth RFID tag circuit element that has an IC circuit part configured to store information and a tag antenna capable of transmission and reception of information, and is disposed on an article; an apparatus for communicating with an RFID tag capable of radio communication with the third RFID tag circuit element and the fourth RFID tag circuit element; and a management device having a database arranged to be accessible from the apparatus, wherein the apparatus comprises: an apparatus antenna device configured to perform radio communication with the third RFID tag circuit element and the fourth RFID tag circuit element; a power control portion capable of changing a power value of the antenna device; an information obtaining portion configured to obtain information via the apparatus antenna device from the third RFID tag circuit element and the fourth RFID tag circuit element, based on the power value controlled by the power control portion; and an association processing portion configured to perform association processing of tag identification information of the fourth RFID tag circuit element with tag identification information of the third RFID tag circuit element, based on a result of comparison between a power value of the apparatus antenna device when the information obtaining portion has obtained information from the fourth RFID tag circuit element and a power value of the apparatus antenna device when the information obtaining portion has obtained information from the third RFID tag circuit element, wherein the database stores the identification information of the third RFID tag circuit element and the identification information of the fourth RFID tag circuit element having been subjected to the association processing by the association processing portion, in association with each other, and the management device identifies a state of taking-out or a state of returning of a corresponding article, by the association in the database between the identification information of the fourth RFID tag circuit element and the identification information of the third RFID tag circuit element.

### BRIEF DESCRIPTION OF THE DRAWINGS

FIG. 1 is a diagram showing a state that a user is taking out an article in a system for article management in an embodiment according to the present invention;

FIG. 2 is a diagram of system configuration showing the entire configuration of the system for article management;

FIG. 3 is a block diagram showing an example of the functional configuration of an RFID tag circuit element disposed on an RFID tag disposed on a user or an article;

FIG. 4 is a function block diagram showing the detailed configuration of a radio frequency circuit;

FIG. 5 is a function block diagram showing the detailed function of a control circuit;

FIG. 6A is a diagram schematically showing a state that a user is taking out an article by hand;

FIG. 6B is a diagram schematically showing a state that a user is taking out an article by hand;

FIG. 7A is a diagram schematically showing a state that a user is taking out an article by hand;

FIG. 7B is a diagram schematically showing a state that a user is taking out an article by hand;

FIG. 8 is a diagram schematically showing a state that a user is taking out an article by hand;

FIG. 9A is a table showing data stored in a nonvolatile memory;

FIG. 9B is a table showing data stored in the nonvolatile memory;

FIG. 10A is a table showing data stored in the nonvolatile memory;

FIG. 10B is a table showing data stored in the nonvolatile memory;

FIG. 11 is a table showing data stored in the nonvolatile memory;

FIG. 12 a table illustrating the association between the tag ID obtained from the RFID tag circuit element disposed on an article tag and the tag ID obtained from the RFID tag circuit element disposed on a name tag;

FIG. 13 is a table schematically showing an example of association information registered in the database on a server;

FIG. 14 is a flowchart showing a control procedure executed by the control circuit;

FIG. 15A is a table illustrating the association between the tag ID obtained from the RFID tag circuit element disposed on an article tag and the tag ID obtained from the RFID tag circuit element disposed on a name tag;

FIG. 15B is a table illustrating the association between the tag ID obtained from the RFID tag circuit element disposed on the article tag and the tag ID obtained from the RFID tag circuit element disposed on the name tag;

FIG. 16 is a flowchart showing a control procedure executed by the control circuit;

FIG. 17 is a diagram showing the state that a user is taking out an article in a modified example with a movable apparatus antenna;

FIG. 18 is a diagram of system configuration showing the entire configuration of a system for article management;

FIG. 19 is a flowchart showing a control procedure executed by a control circuit;

FIG. 20 is a flowchart showing a control procedure executed by the control circuit of a reader in a modified example where the power in the second power mode is appropriately increased or decreased, depending on the number of tag IDs obtained from RFID tag circuit elements related to articles;

FIG. 21 is a system configuration diagram showing the entire configuration of a system for article management in a modified example where notification is made and the power is decreased when a tag ID is obtained from an RFID tag circuit element related to a different user;

FIG. 22 is a flowchart showing a control procedure executed by a control circuit;

FIG. 23 is a diagram showing a state that a user is taking out an article in a modified example where an apparatus antenna is installed near the feet of a user; and

FIG. 24 is a flowchart showing a control procedure executed by a control circuit.

### DESCRIPTION OF THE PREFERRED EMBODIMENTS

An embodiment according to the present invention will be described below, referring to the drawings. The present embodiment is an example where an apparatus for communicating with an RFID tag according to the present invention is applied to a system for article management that manages the take-out state or the return state of articles.

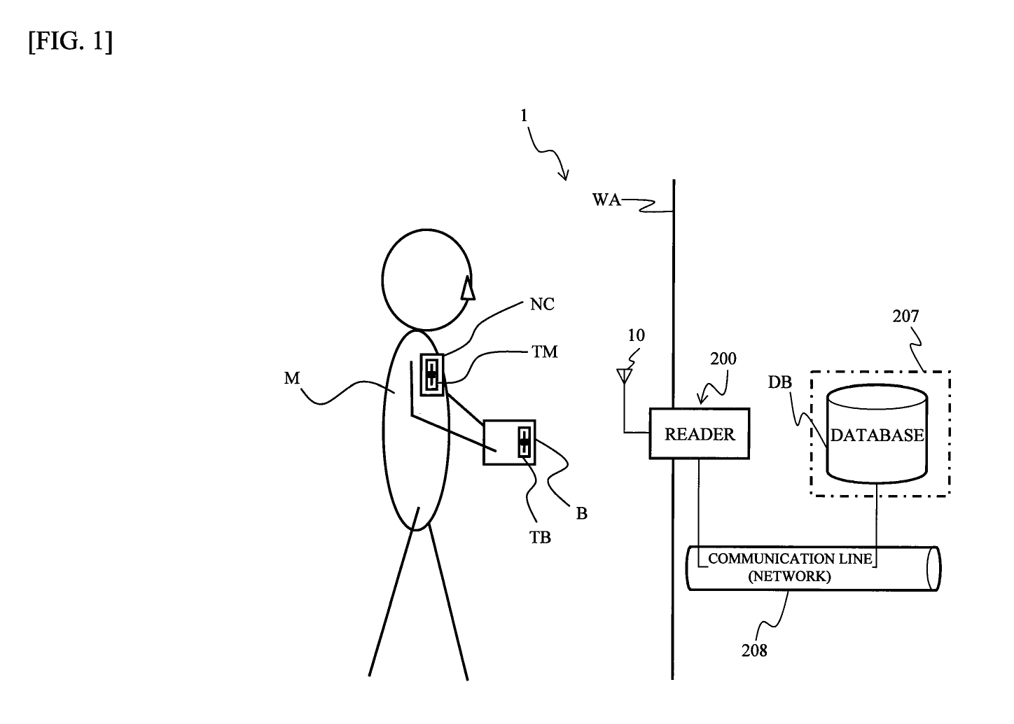

As shown in FIG. 1, in a system 1 for article management in the present embodiment, a user M, who is a person that takes out or returns an article B, holds or carries an RFID tag TM. In the present example, the RFID tag TM is disposed on a name card NC held or carried by the user M. For example, an ID card may be used instead of the name card NC. This RFID tag TM includes an RFID tag circuit element To-M (described later in detail) in which a tag ID, which is tag identification information unique to a user, is written.

Further, an RFID tag TB is disposed on the article B, which is a target object of take-out. This RFID tag TB includes an RFID tag circuit element To-B (described later in detail) in which a tag ID, which is unique to this article B, is written.

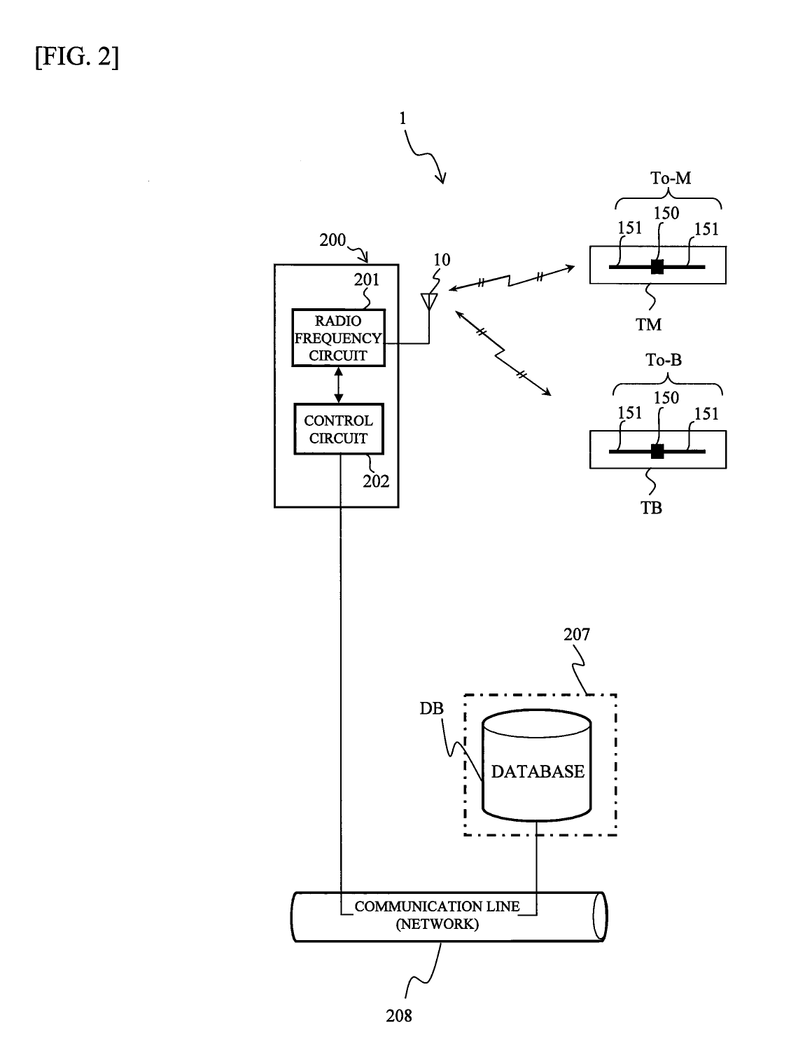

When the user M takes out or returns the article B, information on the RFID tag circuit element To-B (refer to later-described FIG. 2) disposed on the RFID tag TB is read, via the apparatus antenna 10 of a reader 200 disposed, for example, on a wall WA near a doorway. The apparatus for communicating with an RFID tag includes the reader 200, and the apparatus antenna includes the apparatus antenna 10. Herein, further, the reader 200 reads the information on the RFID tag circuit element To-M disposed on the RFID tag TM (refer to later-described FIG. 2) via the apparatus antenna 10 (described later in detail). The information read by the reader 200 is transmitted to the database DB of a server 207 via a communication line, for example, a network 208.

As shown in FIG. 2 and described above, the system 1 for article management includes the reader 200 and the server 207, which is a management device having the database DB.

The reader 200 includes the apparatus antenna 10, a radio frequency circuit 201, and a control circuit 202.

The apparatus antenna 10 transmits and receives signals by radio communication to and from the RFID tag circuit element To-M disposed on the RFID tag TM (hereinafter, referred to as ‘name tag TM’, as appropriate) and the RFID tag circuit element To-B disposed on the RFID tag TB (hereinafter, referred to as ‘article tag TB’, as appropriate). The RFID tag circuit element To-M forms the first RFID tag circuit element or the third RFID tag circuit element, while the RFID tag circuit element To-B forms the second RFID tag circuit element or the fourth RFID tag circuit element.

The radio frequency circuit 201 accesses the IC circuit part 150 of the RFID tag circuit element To-M or To-B via the apparatus antenna 10 by radio communication, using a radio frequency wave, such as a UHF band, a microwave, or a shortwave band. Further, the radio frequency circuit 201 processes a signal having been read from the RFID tag circuit element To-M or To-B.

The control circuit 202 is connected with the radio frequency circuit 201 to control the radio frequency circuit 201.

The RFID tags TM and TB have the respective RFID tag circuit elements To-M and To-B. Both the RFID tag circuit elements To-M and To-B have the IC circuit part 150 that stores information and the tag antenna 151 that is connected with the IC circuit part 150 and is capable of transmission and reception of information. The IC circuit part 150 stores and holds a tag ID in a later-described memory part 155. Each of the tag IDs is tag identification information that is unique and enables identification of a corresponding target object of obtaining information, namely the article B or the user M. The tag IDs may be rewritable.

Then, the control circuit 202 uses the tag ID to make an inquiry to the server 207. As a result, various information that is stored and held by the database DB of the server 207 and is related to the target object, for example, the name of the article or the name of the person is read from the server 207. Incidentally, the memory part 155 may store article information or personal information instead of tag IDs. The data of respective articles B and the personal information of respective users M are input in advance, using, for example, an appropriate terminal, and are stored and held in the database DB of the server 207.

Further, the database DB stores the tag ID of the RFID tag circuit element To-M of the name tag TM and the tag ID of the RFID tag circuit element To-B of the article tag TB, associating the tag IDs with each other. These tag ID of the RFID tag circuit element To-M and the tag ID of the RFID tag circuit element To-B, which are associated with each other, have been subjected in advance to association-processing (described later in detail) by the reader 200.

Then, based on the association, stored in the database DB, between tag ID of the RFID tag circuit element To-B and the tag ID of the RFID tag circuit element To-M, the server 207 identifies and manages the take-out state or the return state of the corresponding article B (described later in detail).

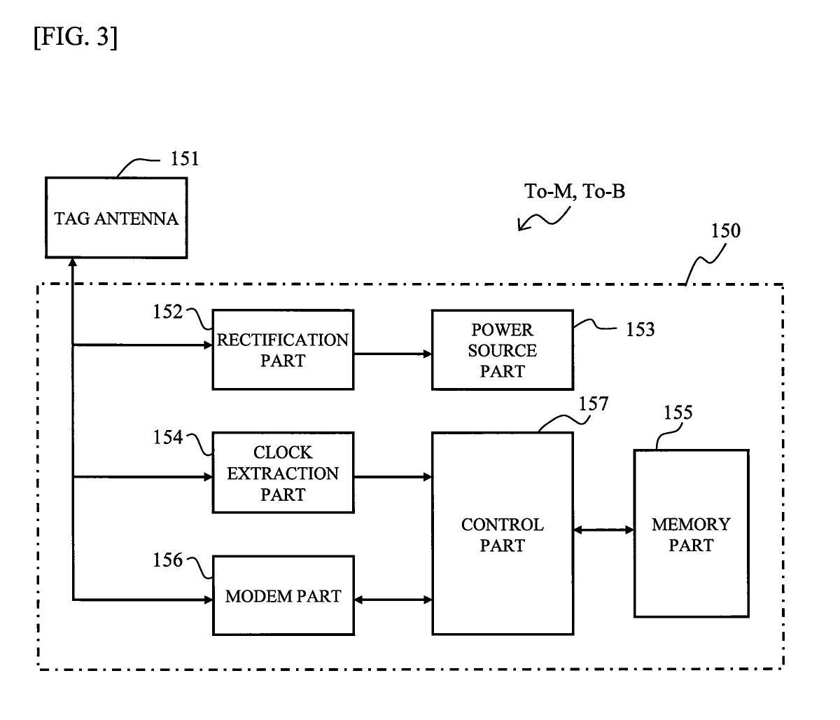

As shown in FIG. 3, the RFID tag circuit elements To-M and To-B include the tag antenna 151 and the IC circuit part 150 connected to the tag antenna 151. As described above, the tag antennas 151 transmit and receive signals to and from the apparatus antenna 10 of the reader 200 contactlessly by radio communication.

The IC circuit part 150 includes a rectification part 152, a power source part 153, a clock extraction part 154, a memory part 155, a modem part 156, and a control part 157. The rectification part 152 rectifies an interrogation wave received by the tag antenna 151. The power source part 153 accumulates the energy of the interrogation wave rectified by the rectification part 152 to make it a driving power source. The memory part 155 stores a certain information signal.

The modem part 156 is connected to the tag antenna 151. The modem part 156 demodulates a communication signal from the apparatus antenna 10 of the reader 200, the communication signal having been received by the tag antenna 151. Further, the modem part 156 modulates a return signal from the control part 157, and transmits the signal as a response signal, in other words, a signal including the tag ID from the tag antenna 151.

The clock extraction part 154 extracts a clock component from the interrogation wave having been received by the tag antenna 151, and supplies the control part 157 with a clock corresponding to the frequency of the clock component.

The control part 157 controls the operation of the RFID tag circuit elements To-M and To-B via parts including the memory part 155, the clock extraction part 154, and the modem part 156. Further, the control part 157 performs control of, for example, interpreting the received signal having been demodulated by the modem part 156, generating a return signal, based on the information signal stored in the memory part 155, returning the return signal from the tag antenna 151 by the modem part 156.

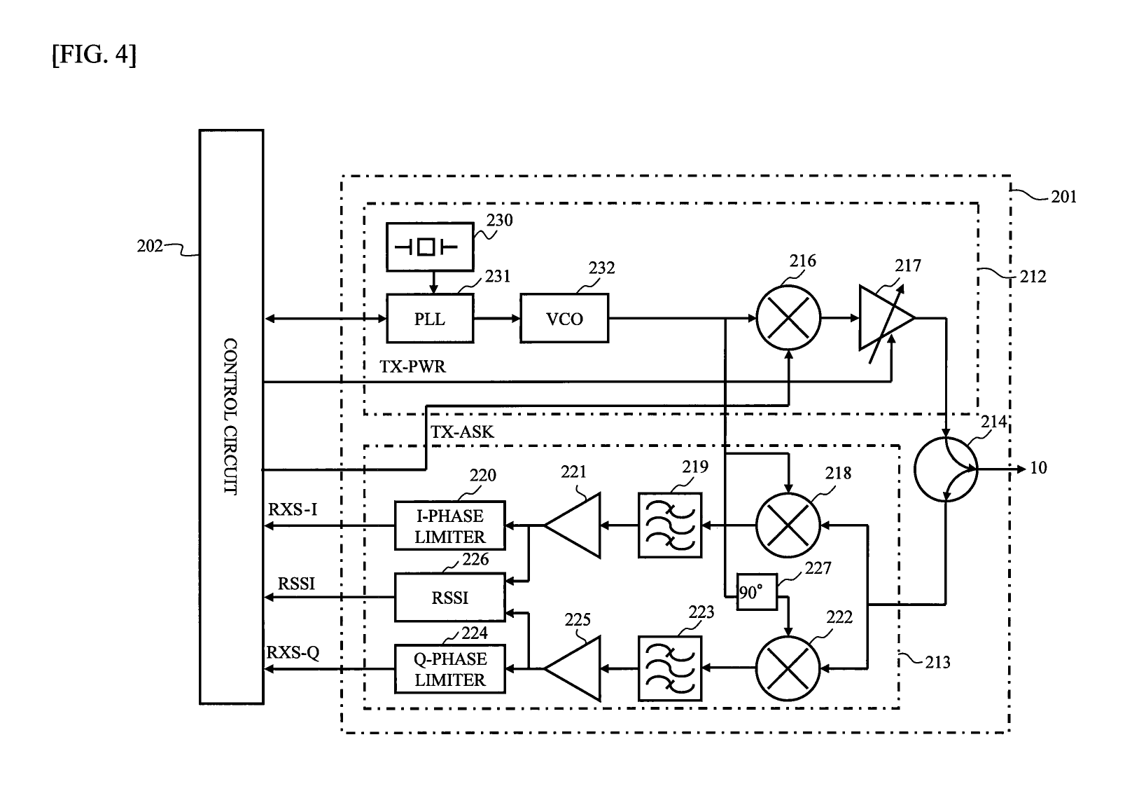

As shown in FIG. 4, the radio frequency circuit 201 accesses information in the IC circuit part 150 of the RFID tag circuit elements To-M and To-B via the apparatus antenna 10. Further, the control circuit 202 of the reader 200 processes signals, which are read from the IC circuit part 150 of the RFID tag circuit elements To-M and To-B to read information, and creates various commands for access to the IC circuit part 150 of the RFID tag circuit elements To-M and To-B.

The radio frequency circuit 201 includes a transmitting portion 212, a receiving portion 213, and a transmit-receive splitter 214.

The transmitting portion 212 transmits signals to the RFID tag circuit elements To-M and To-B via the apparatus antenna 10. That is, the transmitting portion 212 is a block that generates interrogation waves for access to radio tag information in the IC circuit part 150 of the RFID tag circuit elements To-M and To-B. The transmitting portion 212 includes a crystal oscillator 230, a phase locked loop (PLL) 231, a voltage controlled Oscillator (VCO) 232, a transmission multiplying circuit 216, and a gain control transmission amplifier 217.

The crystal oscillator 230 outputs a reference signal of frequency. The PLL 231 and the VCO 232 divide and multiply an output from the crystal oscillator 230 with control by the control circuit 202 to generate a carrier wave with a predetermined frequency. The transmission multiplying circuit 216 modulates the generated carrier wave, based on a signal supplied from the control circuit 202. In this example, the transmission multiplying circuit 216 performs amplitude modulation, based on a TX_ASK signal from the control circuit 202. Incidentally, in a case of amplitude modulation, for example, a variable-gain amplifier may be used instead of the transmission multiplying circuit 216. The gain control transmission amplifier 217 amplifies a modulated wave having been modulated by the transmission multiplying circuit 216, and thereby generates a desired interrogation wave.

In this example, the gain control transmission amplifier 217 generates the interrogation wave by amplification whose gain is determined by the TX_PWR signal from the control circuit 202. For the carrier wave, a frequency of, for example, a UHF band, a microwave band, or shortwave band is used. The output from the gain control transmission amplifier 217 is transferred via the transmit-receive splitter 214 to the apparatus antenna 10 to be supplied to the IC circuit part 150 of the RFID tag circuit elements To-M and To-B. Incidentally, the interrogation wave is not limited to a signal that is modulated as described above, namely a modulated wave, and can be a mere carrier wave.

The response wave which is received via the apparatus antenna 10 from the RFID tag circuit element To-M or To-B is input to the receiving portion 213. That is, the receiving portion 213 includes an I-phase receiving signal multiplying circuit 218, an I-phase band-pass filter 219, an I-phase receiving signal amplifier 221, an I-phase limiter 220, a Q-phase receiving signal multiplying circuit 222, a Q-phase band-pass filter 223, a Q-phase receiving amplifier 225, and a Q-phase limiter 224.

The I-phase receiving signal multiplying circuit 218 multiplies the response wave received via the apparatus antenna 10 from the RFID tag circuit element To-M or To-B by the generated carrier wave and demodulates the wave. The I-phase band-pass filter 219 takes out only the signal of a necessary band from the output of the I-phase receiving signal multiplying circuit 218. The I-phase receiving signal amplifier 221 amplifies the output from the I-phase band-pass filter 219. The I-phase limiter 220 further amplifies the output from the I-phase receiving signal amplifier 221 and converts the output into a digital signal.

The Q-phase receiving signal multiplying circuit 222 multiplies the response wave received by the reader 200 from the RFID tag circuit element To-M or To-B by the carrier wave whose phase has been delayed by 90 degrees by a phase shifter 227 after the generation. The Q-phase band-pass filter 223 takes out only the signal of a necessary band from the output of the Q-phase receiving signal multiplying circuit 222. The Q-phase receiving amplifier 225 amplifies the output from the Q-phase band-pass filter 223. The Q-phase limiter 224 further amplifies the output from the Q-phase receiving amplifier 225 and converts the output into a digital signal.

The signal ‘RXS-I’ that is output from the I-phase limiter 220 and the signal ‘RXS-Q’ that is output from the Q-phase limiter 224 are input to the control circuit 202 to be processed.

Further, the outputs from the I-phase receiving signal amplifier 221 and the Q-phase receiving amplifier 225 are also input to a received signal strength indicator (RSSI) circuit 226. Signals ‘RSSI’ that represent the strength of these signals are input to the control circuit 202. In such a manner, the reader 200 performs demodulation of the response waves from the RFID tag circuit elements To-M and To-B by I-Q orthogonal demodulation.

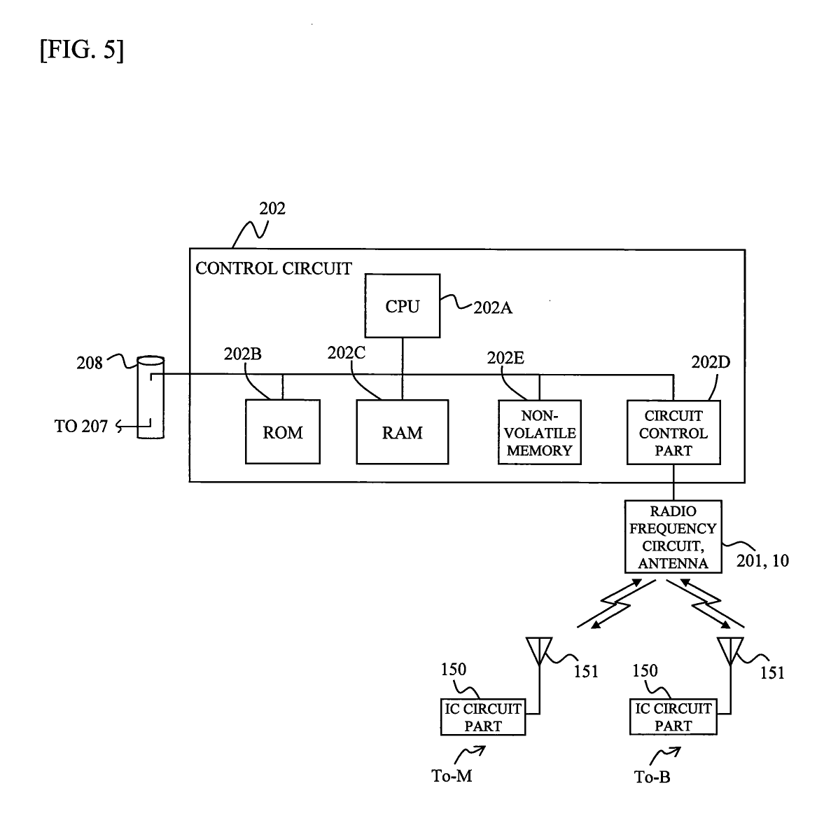

As shown in FIG. 5, the control circuit 202 is a so-called microcomputer. The control circuit 202 includes a CPU 202A, which is a central processing unit, a ROM 202B, a nonvolatile memory 202E, which is, for example, a flash ROM, a RAM 202C, and a circuit control part 202D that performs signal transmission and reception to and from the radio frequency circuit 201. While using the temporary storage function of the RAM 202C, the control circuit 202 performs signal processing according to a program stored in advance in the ROM 202B. The nonvolatile memory 202E stores the tag IDs obtained from the plural RFID tag circuit elements To-M and To-B, relating the IDs with respective corresponding power values.

Further, the control circuit 202 is connected to the communication line 208 (refer to FIG. 1). The control circuit 202 is arranged to be able to exchange information with the server 207 and others including terminals, computers, servers, which are connected to the communication line 208. Incidentally, the server 207 also includes, for example, a CPU, a ROM, and a RAM.

Features of the present embodiment are follows. That is, the reader 200 compares the power at the time of obtaining the tag ID from the RFID tag circuit element To-B of the article tag TB and the power at the time of obtaining the tag ID from the RFID tag circuit element To-M of the name tag TM. Then, according to a result of the comparison, the reader 200 associates the tag ID of the RFID tag circuit element To-B and the tag ID of the RFID tag circuit element To-B with each other. This operation will be described below in detail.

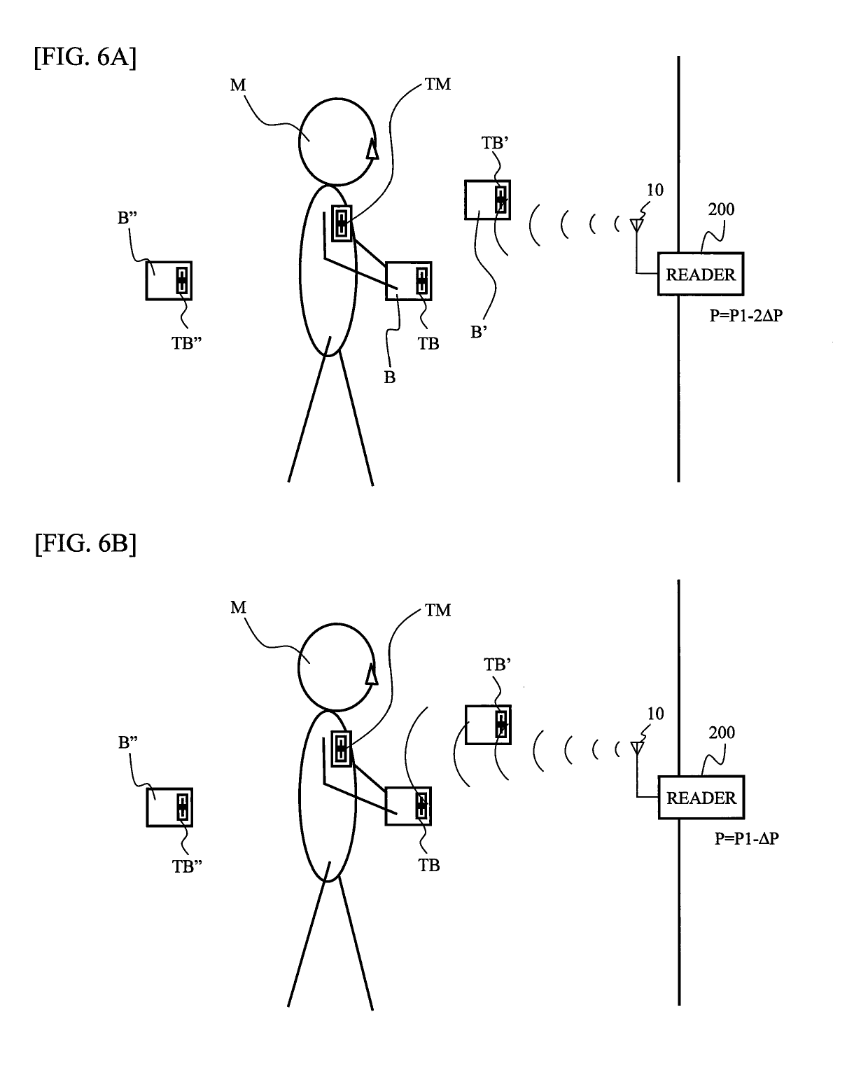

First, the relating between a power value P from the apparatus antenna 10 and the tag ID of the RFID tag circuit elements To-M or To-B disposed on the article tag TB or the name tag TM will be sequentially described, referring to FIGS. 6A to 8.

First, the reader 200 performs setting of the power value P of a signal that is firstly transmitted from the apparatus antenna 10. This power value P is the initial power value Po. With this power value Po having been set, the apparatus antenna 10 transmits a signal, in more details, an information reading signal (later described) that does not specifies a target. Subsequently, the power, which is the power value Po, changes such as to increase by ΔP in this example, and a signal is transmitted from the apparatus antenna 10 with this power value P=Po+ΔP. During these operations, when the tag IDs are obtained from the RFID tag circuit elements To-M and To-B by response signals in response to transmission signals transmitted with respective power values P, the obtained tag IDs are made related to corresponding power values P and stored in the nonvolatile memory 202E.

FIG. 6A schematically shows the state that a signal is transmitted with a power value P=P1−2ΔP from the apparatus antenna 10 when the user M takes out by hand the article B having the article tag TB disposed thereon. In this example, in the vicinity of the user M, in other words, within the area where the reader 200 is able to communicate, an article B′ that the user M has not taken and an article B″ that is located on the back side of the user M are present, in addition to the article B that the user M has taken. An article tag TB is disposed on the article B; an article tag TB′ is disposed on the article B′, which is present on the front side of the user M; and an article tag TB″ is disposed on the article B″.

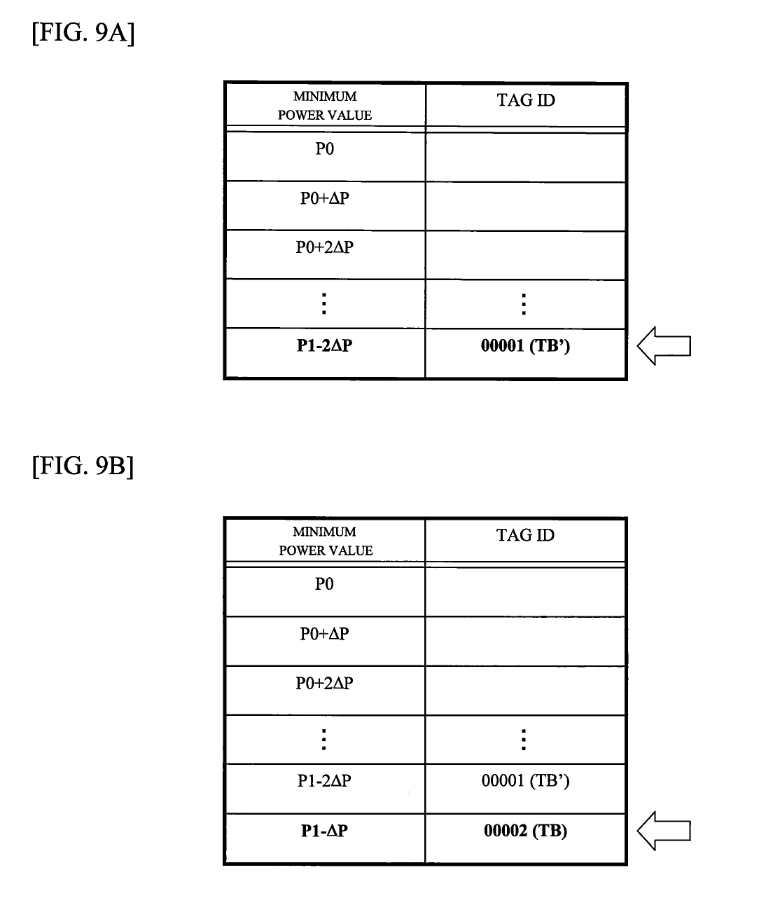

In the shown state, the reader 200 transmits the information reading signal while increasing the power value P described above by ΔP-by-ΔP from Po, as described above. In the shown state, the reader 200 has obtained a tag ID for the first time from the RFID tag circuit element To-B disposed on the article tag TB′. The power value P then is P=P1−2ΔP. Incidentally, ‘P1’ is the minimum power value that enables the reader 200 to obtain the tag ID from the RFID tag circuit element To-M disposed on the name tag TM (Details will be described later). As a result and as described above, the obtained tag ID of the RFID tag circuit element To-B of the article tag TB′ is made related to the corresponding minimum power value P=P1−2ΔP and stored in the nonvolatile memory 202E (refer to FIG. 9A described later).

FIG. 6B schematically shows the state that the reader 200 transmits the information reading signal while further increasing the power value P by ΔP-by-ΔP from the state shown in FIG. 6A. In FIG. 6B, the reader 200 transmits the information reading signal while further increasing the power value P by ΔP-by-ΔP from P=P1−2ΔP described above. In the state shown, the reader 200 has obtained a tag ID from the RFID tag circuit element To-B disposed on the article tag TB for the first time. The power value P then is P=P1−ΔP. As a result and as described above, the obtained tag ID of the RFID tag circuit element To-B of the article tag TB is made related to the corresponding minimum power value P=P1−ΔP and stored in the nonvolatile memory 202E (refer to FIG. 9B described later). Incidentally, at this moment, the above-described article tag TB′ disposed on the article B′ still remains within the area where communication is possible, and accordingly, the tag ID still can be obtained also from the RFID tag circuit element To-B disposed on the article tag TB′.

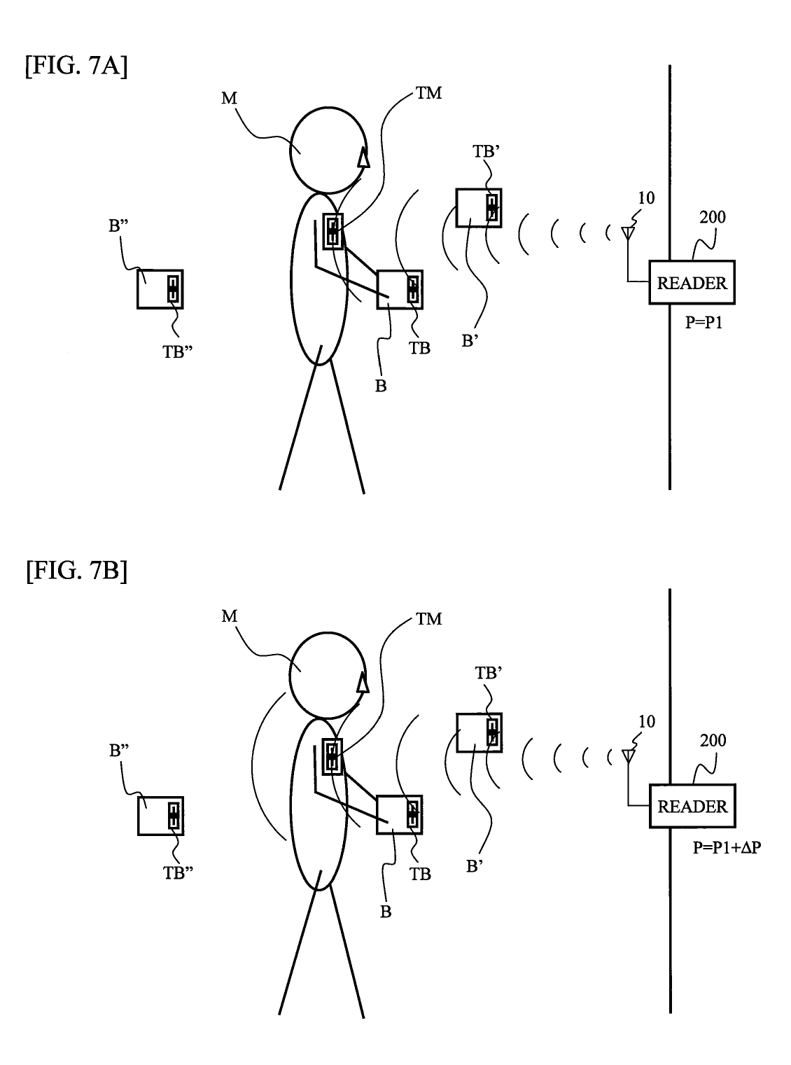

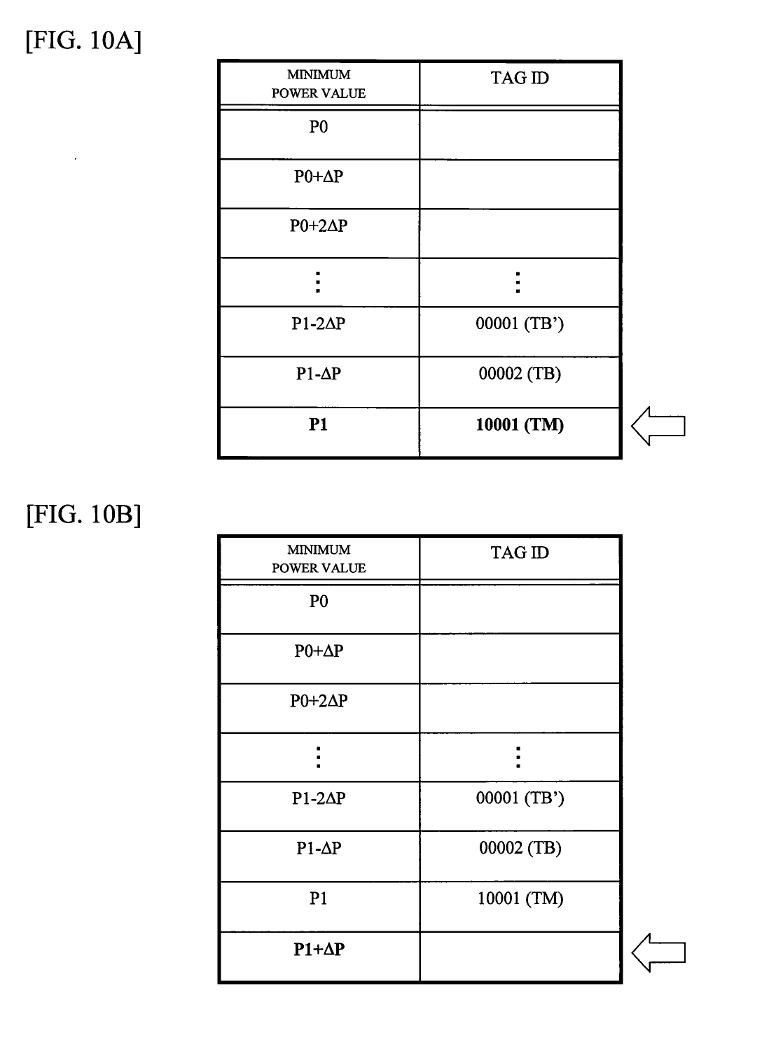

FIG. 7A schematically shows the state that the reader 200 transmits the information reading signal while further increasing the power values P by ΔP-by-ΔP from the state shown in FIG. 6B. In FIG. 7A, the reader 200 transmits the information reading signal while further increasing the power value P by ΔP-by-ΔP from P=P1−ΔP described above. In the state shown, the reader 200 has obtained a tag ID from the RFID tag circuit element To-M disposed on the name tag TM for the first time. The power value P then is P=P1. As a result and as described above, the obtained tag ID of the RFID tag circuit element To-M of the name tag TM is made related to the corresponding minimum power value P=P1 and stored in the nonvolatile memory 202E (refer to FIG. 10A described later). Incidentally, at this moment, the above-described article tags TB′ and TB disposed on the articles B′ and B still remain within the area where communication is possible, and accordingly, the tag IDs still can be obtained also from the RFID tag circuit elements To-B and To-B disposed on the article tags TB′ and TB.

FIG. 7B schematically shows the state that the reader 200 transmits the information reading signal while further increasing the power value P from the state, shown in FIG. 7A, that the power value P is P=P1. At the moment in the state shown, P=P1+ΔP. Similarly to the above description, the above-described article tags TB′ and TB disposed on the articles B′ and B, and the name tag TM disposed on the name card NC still remain within the area where communication is possible. As a result, the tag IDs still can be obtained from the RFID tag circuit elements To-B and To-B disposed on the article tags TB′ and TB and the RFID tag circuit element To-M disposed on the name card TM.

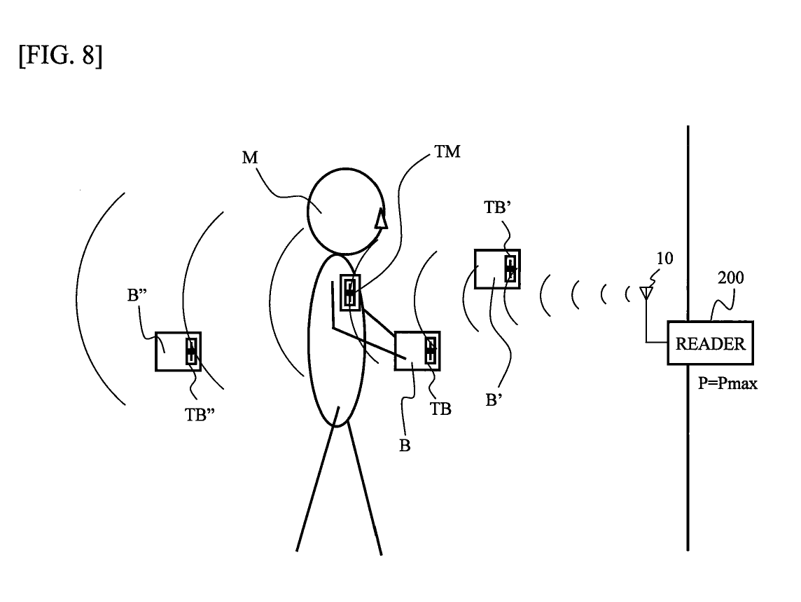

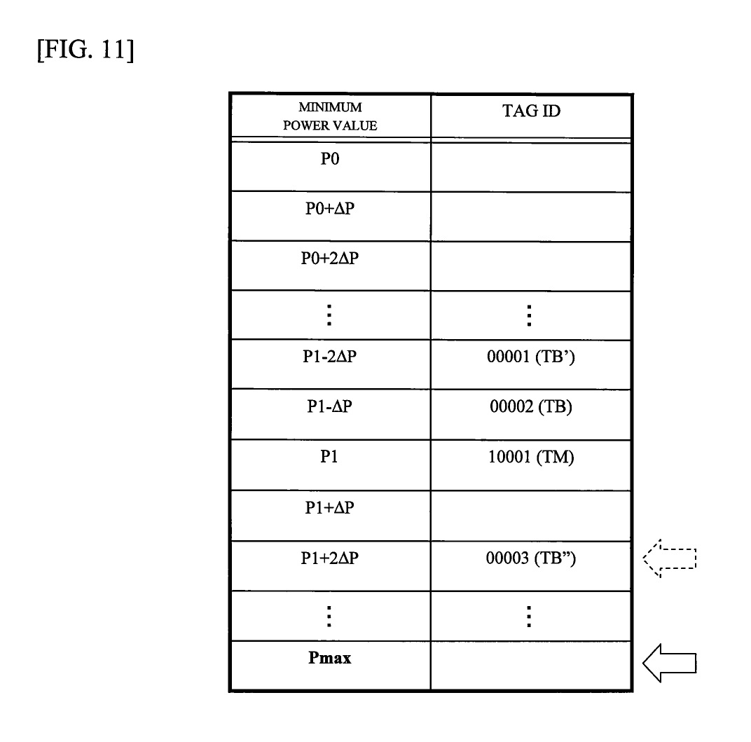

FIG. 8 schematically shows the state that the reader 200 transmits the information reading signal while further increasing the power value P by ΔP-by-ΔP from the state shown in FIG. 7B. In FIG. 8, the reader 200 further increases the power value P by ΔP-by-ΔP from P=P1+ΔP described above, and obtains a tag ID from the RFID tag circuit element To-B disposed on the article B″ for the first time. Further, similarly to the above description, the obtained tag ID of the RFID tag circuit element To-B of the article tag TB″ is made related to the corresponding minimum power value and stored in the nonvolatile memory 202E (refer to FIG. 11 described later). The state shown represents the state that the power value thereafter has further increased by ΔP-by-ΔP, and the power value has become the maximum power value Pmax. In this state, the above-described article tags TB′, TB, and TB″ disposed on the articles B′, B, and B″, and the name tag TM disposed on the name card NC still remain within the area where communication is possible. Accordingly, the tag IDs can be obtained from the three RFID tag circuit elements To-B disposed on the article tags TB′, TB, and TB″, and the RFID tag circuit element To-M disposed on the name tag TM.

As has been described above, the reader 200 transmits the information reading signal while increasing the power value P by ΔP-by-ΔP from Po. Then, when a tag ID is obtained from the RFID tag circuit element To, the power value then and the obtained tag ID are made related to each other and stored in the nonvolatile memory 202E. This processing is repeated until the power value P becomes Pmax that is the maximum power value.

The data contents that have been stored in the nonvolatile memory 202E of the reader 200 through the operational behaviors, which having been sequentially described with reference to the above FIGS. 6A, 6B, 7A, 7B, and 8, will be described, referring to FIGS. 9A, 9B, 10A, 10B, and 11. In the respective figures, the nonvolatile memory 202E of the reader 200 accumulates the power values P, of the apparatus antenna 10, taken when a tag ID is obtained from the RFID tag circuit element To-M and To-B for the first time, in other words, the minimum power values and the corresponding tag IDs such that the minimum power values and the corresponding tag IDs are related to each other.

That is, first, FIG. 9A corresponds to the state shown in FIG. 6A. As described above, the reader 200 transmits the information reading signal, while increasing the power value P from the initial value Po by ΔP-by-ΔP such that the power value increases from Po to Po+ΔP, and to Po+2ΔP. Then, when the power value has become P=P1−2ΔP as described above, a tag ID is obtained from the RFID tag circuit element To-B disposed on the article tag TB′ for the first time. As a result, the nonvolatile memory 202E stores, as shown in FIG. 9A, the minimum power value P1−2ΔP and the corresponding tag ID such that the minimum power value P1−2ΔP and the corresponding tag ID are related to each other. Incidentally, the tag ID is described as ‘00001’ in the figure for convenience (similarly hereinafter).

FIG. 9B corresponds to the state shown in FIG. 6B. As described above, subsequently to the power value P=Po+2ΔP, the reader 200 continues to transmit the information reading signal while further increasing the power value P by ΔP-by-ΔP. Then, when, as described above, the power value P has become P=P1−ΔP, a tag ID is obtained from the RFID tag circuit element To-B disposed on the article tag TB for the first time. As a result, as shown in FIG. 9B, the nonvolatile memory 202E newly stores the minimum power value P=P1−ΔP and the corresponding tag ID, namely ‘00002’0 shown in the figure such that the minimum power value P=P1−ΔP and the corresponding tag ID are related to each other (refer to the arrow). In other words, FIG. 9B shows that, when the power value P is P=P1−ΔP, tag IDs are obtained respectively from the RFID tag circuit element To-B of the article tag TB′ and the RFID tag circuit element To-B of the article tag TB.

FIG. 10A corresponds to the state shown in FIG. 7A. As described above, subsequently to the power value P=P1−ΔP, the reader 200 continues to transmit the information reading signal while further increasing the power value P by ΔP-by-ΔP. Then, when, as described above, the power value P has become P=P1, a tag ID is obtained from the RFID tag circuit element To-M disposed on the name tag TM for the first time. As a result, as shown in FIG. 10A, the nonvolatile memory 202E newly stores the minimum power value P=P1 and the corresponding tag ID, namely ‘10001’ shown in the figure such that the minimum power value P=P1 and the corresponding tag ID are related to each other (refer to the arrow). In other words, FIG. 10A shows that, when the power value P is P=P1, tag IDs are obtained respectively from the RFID tag circuit element To-B, To-B of the article tag TB′, TB and the RFID tag circuit element To-M of the name tag TM.

FIG. 10B corresponds to the state shown in FIG. 7B. As described above, subsequently to the power value P=P1, the reader 200 continues to transmit the information reading signal while further increasing the power value P by ΔP-by-ΔP. The figure shows the state when power value P has become P=P1+ΔP. As described above, there is no tag ID that is obtained for the first time with this power value. As a result, there is no tag ID that is stored being related to the power value P=P1+ΔP. Similarly to the above description, FIG. 10B shows that, when the power value P is P=P1+ΔP, tag IDs are obtained respectively from the RFID tag circuit element To-B, To-B of the article tag TB′, TB and the RFID tag circuit element To-M of the name tag TM.

FIG. 11 corresponds to the state shown in FIG. 8. As described above, subsequently to the power value P=P1+ΔP, the reader 200 continues to transmit the information reading signal while further increasing the power value P by ΔP-by-ΔP. Then, when, as described above, the power value P has become P=P1+2ΔP, a tag ID is obtained from the RFID tag circuit element To-B disposed on the article tag B″ for the first time. As a result, as shown in FIG. 11, the nonvolatile memory 202E newly stores the minimum power value P=P1+2ΔP and the corresponding tag ID, namely ‘00003’ shown in the figure such that the minimum power value P=P1+2ΔP and the corresponding tag ID are related to each other (refer to the arrow). Subsequently, as described above, the reader 200 further increases the power value P by ΔP-by-ΔP from the above-described power value P=P1+2ΔP up to Pmax. However, there is no tag ID that is obtained after the above for the first time. Accordingly, there is no tag ID that is stored being related to a minimum power value that is greater than P1+2ΔP. In other words, FIG. 11 shows that, with the power value P=P1+2ΔP, tag IDs are obtained respectively from the three RFID tag circuit elements To-B of the article tags TB′, TB, and TB″, and the RFID tag circuit element To-M of the name tag TM. Incidentally, the same result is obtained also with the power value P=Pmax.

Now, as a main part of the present embodiment, description will be made on a method in which the reader 200 associates the tag ID obtained from the RFID tag circuit element To-B of the article tag TB and the tag ID obtained from the RFID tag circuit element To-M of the name tag TM with each other.

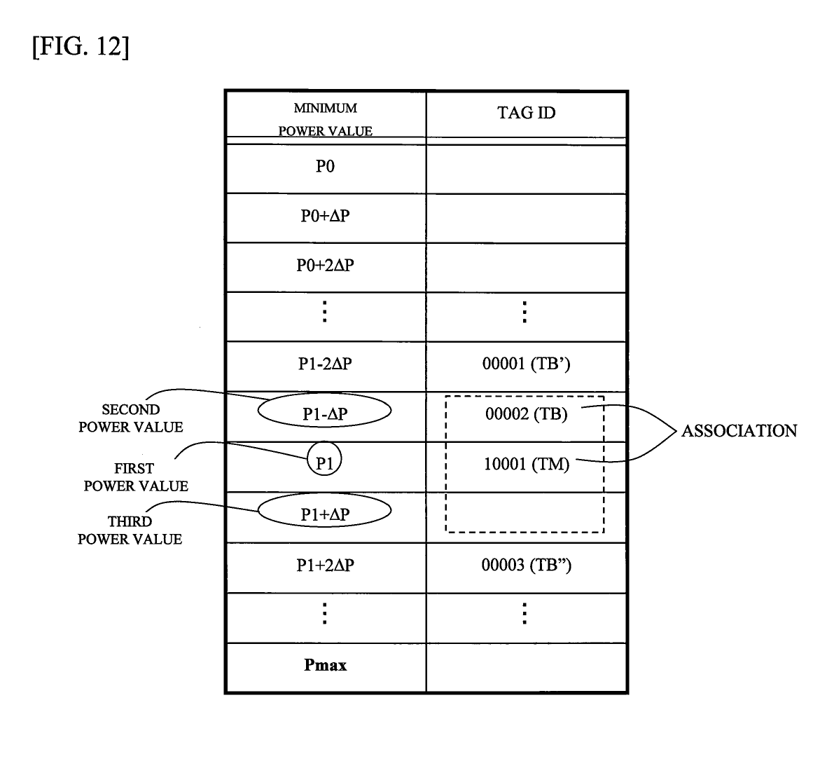

As shown in FIG. 12, which is almost the same as FIG. 11, the reader 200 obtains the tag ID ‘10001’ having been obtained from the RFID tag circuit element To-M of the name tag TM disposed on the name card NC and the corresponding minimum power value P=P1, which are stored in the nonvolatile memory 202E. Incidentally, P1 corresponds to the first power value.

Then, from all of the tag IDs of the RFID tag circuit elements To-M, To-B stored in the nonvolatile memory 202E, tag IDs of RFID tag circuit elements, for which corresponding minimum power values P are present within a certain area including the above-described P1, are extracted. Regarding the certain area, for example, tag IDs of the RFID circuit elements, for which corresponding minimum power values P are present in an area greater than or equal to the second power value P1−ΔP and smaller than or equal to the third power value P1+ΔP, in other words, in an area P1−ΔP≦P≦P1+ΔP, are extracted.

As a result, in the example shown in FIG. 12, the tag ID ‘00002’ of the RFID tag circuit element To-B of the article tag TB disposed on the article M, for which the corresponding minimum power value P was P=P1−ΔP, is extracted. Then, the extracted tag ID ‘00002’ of the RFID tag circuit element To-B of the article tag TB is made associated with the tag ID ‘10001’ of the RFID tag circuit element To-M of the name tag TM.

Then, the reader 200 outputs the above-described association information, to the server 207 via the communication line 208. As a result, the tag ID of the RFID tag circuit element To-M disposed on the name tag TM and the tag ID of the RFID tag circuit element To-B disposed on the article tag TB are stored in the database DB in a state that these IDs are associated with each other.

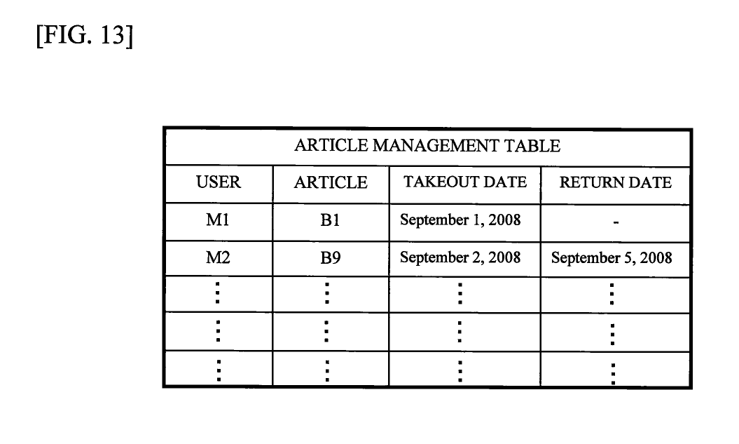

As shown in FIG. 13, in the database DB of the server 207, an article management table including users, articles, take-out dates, and return dates is registered.

In FIG. 13, in the column ‘user’, identification information on a user M who has taken out or returned an article B, in other words, information such as the name of the user is recorded. Further, in the column ‘article’, identification information on the article B that has become the target object of the take-out or the return, in other words, information such as the name of the article, the model number, or the equipment number, is recorded. Further, in the columns ‘take-out date’ and ‘return date’, the dates when these taking-out and returning were performed are recorded.

Herein, in general, in a case where a person handles an article, holding it by hand, and an RFID tag is disposed on both of the person and the article, these two RFID tags are in a state of being comparatively close to each other in terms of position. In the present embodiment, the server 207 performs article management, using this fact, and automatic registration is performed into the database DB. That is, by the above-described method, the reader 200 detects the closeness between the RFID tag circuit element To-M related to a name card NC and the RFID tag circuit element To-B related to an article B that occurs when a user M tries to take out or return the article B. Then, the reader 200 associates these tag IDs with each other, and transmits information on the association as association information, to the server 207. When the above-described association information on a certain article B has been transmitted for the first time to the server 207, the server 207 records this information as taking-out of this article B. Further, when the above-described association information on the same article B has been thereafter transmitted to the server 207, the server 207 records this information as returning of the article B. Then, a similar procedure is thereafter repeated. As a result, taking-out and returning by all users M can be automatically managed for all articles B.

Incidentally, as described above, in the database DB, the tag ID of the RFID tag circuit element To-B of the article tag TB disposed on each article B and the identification information on this article B itself, such as the name, the model number, and the equipment number, are stored being related to each other in advance. Similarly, the tag ID of the RFID tag circuit element To-M of the name tag TM disposed on each name card NC and identification information on the user M corresponding to this name card NC, such as the name of the user, are stored in the database DB, being related to each other in advance. Accordingly, upon input of association information via the reader 200 in the above-described manner, the server 207 accesses the database DB, with the tag ID included in the association information as the key. With this arrangement, the server 207 obtains, for example, the name of the user M or the name of the article B, and performs registration, as shown in FIG. 13, using these. Incidentally, the arrangement may be made such that the server 207 registers a tag ID itself.

In the example shown in FIG. 13, FIG. 13 shows that a user M1 took out an article B1 on Sep. 1, 2008 and has not yet returned the article B1, and that a user M2 took out an article B9 on Sep. 2, 2008 and returned the article B9 on Sep. 5, 2008. This article management table is displayed on a display part, not shown, of the server 207, when the administrator of the server 207 performs an appropriate operation. Incidentally, arrangement may be made such that display can be performed on the display part of the reader 200 by an appropriate operation. Further, arrangement may be made such that display is viewable from the side of a user M via, for example, an appropriate operation terminal.

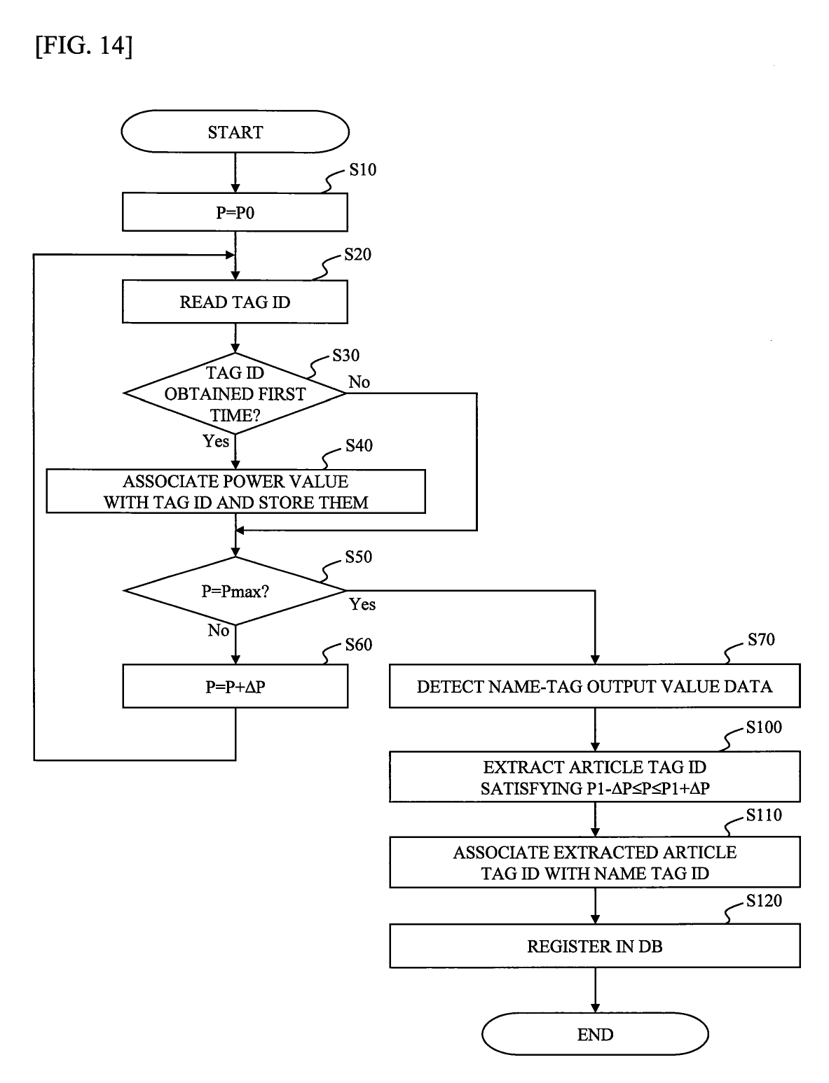

In order to execute what has been described above, the control circuit 202 of the reader 200 executes the control procedure shown in FIG. 14.

That is, in FIG. 14, for example, when the power of the reader 200 is turned on, this flow starts, which is represented by ‘START’ in the figure.

First, in step S10, the control circuit 202 sets the power value P from the apparatus antenna 10 to a predetermined initial power value Po.

Subsequently, in step S20, the control circuit 202 outputs a control signal to the transmitting portion 212 of the radio frequency circuit 201. As a result, the crystal oscillator 230, the PLL 231, and the VCO 232 generates a carrier wave of an appropriate UHF band, for example, 915 MHz, and the generated carrier wave is modulated and amplified, based on the control signal. Then, based on a power value P having been set at this moment, in other words, having been set in step S10 or in step S60 described later, a reading signal for the RFID tag circuit elements To is transmitted via the transmit-receive splitter 214 and the apparatus antenna 10. Incidentally, the RFID tag circuit elements To are, in detail, the RFID tag circuit element To-M related to the user M and the RFID tag circuit element To-B related to the article. Hereinafter, as appropriate, these will be collectively referred to as ‘an RFID tag circuit element To’. Incidentally, this reading signal is a nonspecific reading signal that does not specify a reading target (similar hereinafter). Then, the control circuit 202 receives, via the apparatus antenna 10 and the radio frequency circuit 201, response signals that includes a tag ID having been transmitted from the above-described RFID tag circuit elements To located in an area, where communication is possible, in response to the reading signal. This procedure executed by the control circuit 202 corresponds to a function as an information obtaining portion.

Then, the process moves to step S30, and the control circuit 202 determines whether or not there is a tag ID that has been obtained in step S20 for the first time among the tag IDs that were obtained in step S20. This determination can be made such that the control circuit 202, for example, after obtaining a tag ID, accesses the nonvolatile memory 202E with this tag ID as the key and determines whether or not this tag ID is stored in the nonvolatile memory 202E. If there is a tag ID that was obtained for the first time, the determination in step S30 is satisfied, and the process moves to step S40.

In step S40, the control circuit 202 relates the tag ID that was obtained in step S20 for the first time and the power value P in step S20 corresponding to this tag ID, to each other. Then, the control circuit 202 accesses the nonvolatile memory 202E, and stores the tag ID and the power value P, which have been made related to each other as described above, in the nonvolatile memory 202E. This procedure executed by the control circuit 202 corresponds to a function as a storage processing portion (refer to FIG. 9A for example). Subsequently, the process moves to the next step S50.

On the other hand, in step S30, if there is no tag ID that has been obtained for the first time, the determination is not satisfied, and the process directly moves to step S50.

In step S50, the control circuit 202 determines whether or not the power value P from the apparatus antenna 10 has at this moment reached the predetermined maximum power value Pmax. If not P=Pmax, namely, P<Pmax, the determination is not satisfied, and the process proceeds to step S60. In step S60, the control circuit 202 increases the power value P by adding ΔP to the value of the power value P. Subsequently, the process returns to step S20 and repeats the same procedure.

As has been described above, during when P<Pmax, while increasing the power value P from Po sequentially by ΔP-by-ΔP, the control circuit 202 transmits a reading signal from the apparatus antenna 10. If there is a response from an RFID tag circuit element To, the control circuit 202 stores the tag ID together with the power value then and thus accumulates tag IDs and power values (refer to above-described FIGS. 9A, 9B, 10A, 10B, and 11). Then, when the increasing power value P has reached P=Pmax, the determination in step S50 is satisfied and the process moves to step S70.

In step S70, the control circuit 202 accesses the nonvolatile memory 202E, and refers to all data that have been sequentially stored through the repeat in step S40, wherein the tag IDs of RFID tag circuit elements To and the power values P have been made related to each other. Then, the control circuit 202 obtains the data at the time the tag ID of the RFID tag circuit element To-M of a name tag TM was obtained for the first time. This procedure executed by the control circuit 202 corresponds to a function as a detection portion. Incidentally, the above-described data is, in other words, data for which the minimum power value and the corresponding tag ID are made related to each other, and will be referred to as ‘name-tag power value data’, as appropriate. Incidentally, in the example, the minimum power value P for the name-tag power value data is P=P1.

Subsequently, in step S100, the control circuit 202 accesses the nonvolatile memory 202E. Then, the control circuit 202 again refers to all the data that have been sequentially stored through the repeat in step S40, wherein the tag IDs of RFID tag circuit elements To and the power values P have been made related to each other. Then, based on the name-tag power value data obtained in step S70, the control circuit 202 extracts the tag ID of an RFID tag circuit element To-B related to an article B for which the corresponding power value P is present in a certain area including the above-described P1. This procedure executed by the control circuit 202 corresponds to a function as an extraction portion. In this example, the certain area is P1−ΔP≦P≦P1+ΔP, as described above.

Then, the process moves to step S110, and the control circuit 202 associates the tag ID related to the article B having been extracted in step S100, with the tag ID related to the above-described name tag TM, as association information. This procedure executed by the control circuit 202 corresponds to a function as an association processing portion.

Subsequently, in step S120, the control circuit 202 outputs the association information created in step S10 to the server 207 via the communication line 208. As a result, the tag ID of the RFID tag circuit element To-M of the name tag TM and the tag ID of the RFID tag circuit element To-B of the article tag TB having been made associated with each other as described above are registered and stored in the database DB, being associated with each other. Further, the server 207 creates or updates a corresponding record of the article management table in the database DB by the above-described method. Then, the control circuit 202 terminates this flow.

In the above description, step S10 and step S60, in FIG. 14, that the control circuit 202 of the reader 200 executes function as a power control portion set forth in the respective corresponding claims.

As has been described above, in the present embodiment, tag IDs are obtained while the power of the apparatus antenna 10 is appropriately changed, and the power at the time the tag ID of an RFID tag circuit element To-B is obtained, and the power at the time the tag ID of an RFID tag circuit element To-M is obtained, are compared. Then, depending on whether or not the two powers are substantially the same as a result of the comparison, these two tag IDs are made associated with each other in step S110. With this arrangement, closeness between an RFID tag circuit element To-B and an RFID tag circuit element To-M, which occurs when a user M takes out an article B by hand or returns it, is detected. As a result, it is possible to manage the user M who takes out or returns the article B and the article B that is taken out or returned, associating the user M and the article B with each other with a simple control and a high accuracy.

Further, in the present embodiment, particularly, it is only necessary to obtain tag IDs from an RFID tag circuit element To-M and an RFID tag circuit element To-B while sequentially increasing the power of the apparatus antenna 10, for example, increasing by ΔP-by-ΔP in the above-described example. That is, it is not necessary to perform complicated operation such as to change the power little by little, or stop or retry reading of tag IDs, depending on a result of obtaining tag IDs. As a result, it is possible to reliably and easily perform article management by a comparatively simple method.

The present invention is not limited to the above-described embodiment, and various modifications can be made without departing from the spirit and concept of the present invention. Such modified examples will be sequentially described below.

(1) A case of having detected the tag of a name card first and subsequently searching for the tag of an article in the vicinity of the name card:

in the above-described embodiment, while the power of the apparatus antenna 10 is sequentially changed until the power value P reaches the maximum power value Pmax, tag IDs are obtained from the RFID tag circuit element To-M related to the name tag TM and the RFID tag circuit element To-B related to the article B. However, the present invention is not limited thereto. That is, after the power value P of the apparatus antenna 10 is sequentially changed and the tag ID is obtained from the RFID tag circuit element To-M related to the name tag TM, the power may be further changed to obtain a tag ID from the RFID tag circuit element To-B of an article B that is present in the vicinity of the name tag TM. Such a modified example will be sequentially described below.

In the present modified example, ‘a first mode’ and ‘a second mode’ are arranged. The first mode is aimed at obtaining a tag ID from an RFID tag circuit element To-M by sequentially changing the power of the apparatus antenna 10. The second mode is aimed at obtaining a tag ID from an RFID tag circuit element To-B by further changing the power after obtaining the tag ID from the RFID tag circuit element To-M in the first mode. In this case, if a tag ID is obtained from an RFID tag circuit element To-B with a power that is comparatively close to the power value at the time the tag ID has been obtained from the RFID tag circuit element To-M, it can be determined that the position of the RFID tag circuit element To-B is in an area close to the position of the RFID tag circuit element To-M.

The reader 200, first in the ‘the first mode’, as shown in the FIG. 7A similar to the above-described embodiment, transmits an information reading signal that does not specify a target object from the apparatus antenna 10 with the power value P having been initially set, namely, the initial power value Po. Subsequently, the reader 200 increases the power with the above-described power value P=Po by ΔP-by-ΔP. Incidentally, in the present modified example, even if tag IDs are obtained from RFID tag circuit elements T0-B disposed on an article tag TB′ and TB, storage operation to the nonvolatile memory 202E, as in the above-described embodiment, is not performed at this moment. Then, when, as shown in FIG. 7A, the power value P has increased until the power value P becomes P=P1, which is a fourth power value, a tag ID is obtained for the first time from an RFID tag circuit element To-M disposed on a name tag TM. As a result, as described above, the obtained tag ID of the RFID tag circuit element To-M of the name tag TM is stored in the nonvolatile memory 202E, being related to the corresponding power value P=P1. Further, at this moment, similarly to the above-described embodiment, the above-described article tags TB′, TB disposed on the articles B′, B are already in an area where communication is possible, and tag IDs are obtained also from the RFID tag circuit elements To-B, To-B disposed on the article tags TB′, TB. After the tag IDs are obtained from the RFID tag circuit element To-M disposed on the name tag TM, as described above, the reader 200 changes the mode to ‘the second power mode’.

FIG. 7B, which is similar to the above-described embodiment, shows the state that the reader 200 changes the mode from the above-described state, described above using FIG. 7A, of the power value P=P1, to the ‘the second mode’ and transmits the information reading signal while further increasing the power value P. Incidentally, the power value at this moment is P=P1+ΔP, which is the fifth output power value. Incidentally, after moving to the second mode, the reader 200 may transmit the information reading signal with power value P1 of the same value instead of increasing the value from the first mode. Similarly to the above description, in this state, the article tags TB′, TB disposed on the articles B′, B and the name tag TM disposed on the name card NC are still in an area where communication is possible, and tag IDs are continuously obtained from these RFID tag circuit elements To-B, To-B and the RFID tag circuit element To-M.

In the present modified example, after a tag ID is obtained, as shown in FIG. 7A, for the first time with the power P1 from the RFID tag circuit element To-M of a name tag TM, the mode is changed to the second mode, and, as shown in FIG. 7B, the reading signal is transmitted with a power value higher than or equal to P1, which is P=P1+ΔP in the above-described example. Subsequently, in reverse this time, similar to the above-described embodiment as shown in FIG. 6A, the reading signal is transmitted with a power value smaller than the power P1, which is P=P1−2ΔP in the present example.

That is, in FIG. 6A, the reader 200 transmits the reading signal with the power value P=P1−2ΔP, which is the sixth power. As a result, only the RFID tag circuit element To-B of the article tag TB′ disposed on the article B′ enters an area where communication is possible. On the other hand, the RFID tag circuit element To-M related to the name tag TM and the RFID tag circuit element To-B related to the article B, which have been until just before in an area where communication has been possible, are out of the area where communication is currently possible. The reader 200 obtains a tag ID only from the RFID tag circuit element To-B of the article tag TB′.

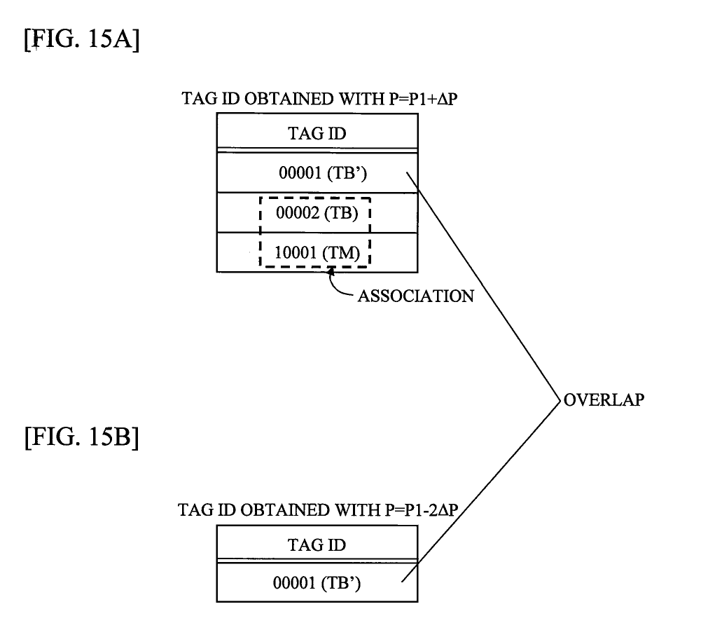

The reader 200 in the present modified example, after the mode is changed to the second mode, tag IDs having been obtained, corresponding to the information reading signal, from RFID tag circuit elements To and the power value then are stored in the nonvolatile memory 202E, being related to each other, similarly to the above-described embodiment. This processing is repeatedly performed after the process has moved to the second mode. The data contents which have been stored in the nonvolatile memory 202E of the reader 200 through the operational behaviors, which have been sequentially described with reference to FIGS. 7B and 6A, are shown in FIGS. 15A and 15B.

In FIG. 15A, when the reading signal is transmitted with the power value P=P1+ΔP after the mode has been moved to ‘the second mode’ as shown in FIG. 7B, the three tag IDs of the tag ID ‘00001’ of the RFID tag circuit element To-B of the article tag TB′, the tag ID ‘00002’ of the RFID tag circuit element To-B of the article tag TB, and the tag ID ‘10001’ of the RFID tag circuit element To-M of the name tag TM are obtained. As a result, as shown in FIG. 15A, in the nonvolatile memory 202E and as tag IDs obtained with the power value P1+ΔP, two tag IDs, namely, the tag ID of the RFID tag circuit element To-B of the article tag TB′ and the tag ID of the RFID tag circuit element To-B of the article tag TB are stored excluding the tag ID of the RFID tag circuit element To-M related to the name tag TM. Incidentally, the three tag IDs may be stored instead of excluding the tag ID of the RFID tag circuit element To-M of the name tag TM.

In FIG. 15B, as has been described with reference to FIG. 6A, when the reading signal is transmitted with the power value P=P1−2ΔP by decreasing the power from the state shown in above-described FIG. 7B, the tag ID ‘00001’ of the RFID tag circuit element To-B of the article tag TB′ is obtained. As a result, as shown, in the nonvolatile memory 202E, only the tag ID of the RFID tag circuit element To-B of the article tag TB′ is stored as a tag ID obtained with the power value P1−2ΔP.

Further, as a feature of the present modified example, from the storage result shown in FIG. 15A with the power value P=P1+ΔP, in other words, from the storage result in which the tag ID of the RFID tag circuit element To-M related to the name tag TM is excluded, the overlap with the storage result shown in FIG. 15B with the power value P=P1−2ΔP is removed in associating tag IDs with each other. That is, from the two tag IDs ‘00001’ and ‘00002’ of the RFID tag circuit elements To-B, To-B related to the article tags TB′, TB shown in FIG. 15A, the tag ID ‘00001’ of the RFID tag circuit element To-B related to the article tag TB′ shown in FIG. 15B is removed.

By this removal, the tag ID ‘00002’ of the RFID tag circuit element To-B related to the article tag TB is determined to be a tag ID to be made associated with the tag ID of the RFID tag circuit element To-M related to the name tag TM. Then, this determined tag ID ‘00002’ of the RFID tag circuit element To-B is made associated with the tag ID ‘10001’ of the RFID tag circuit element To-M.

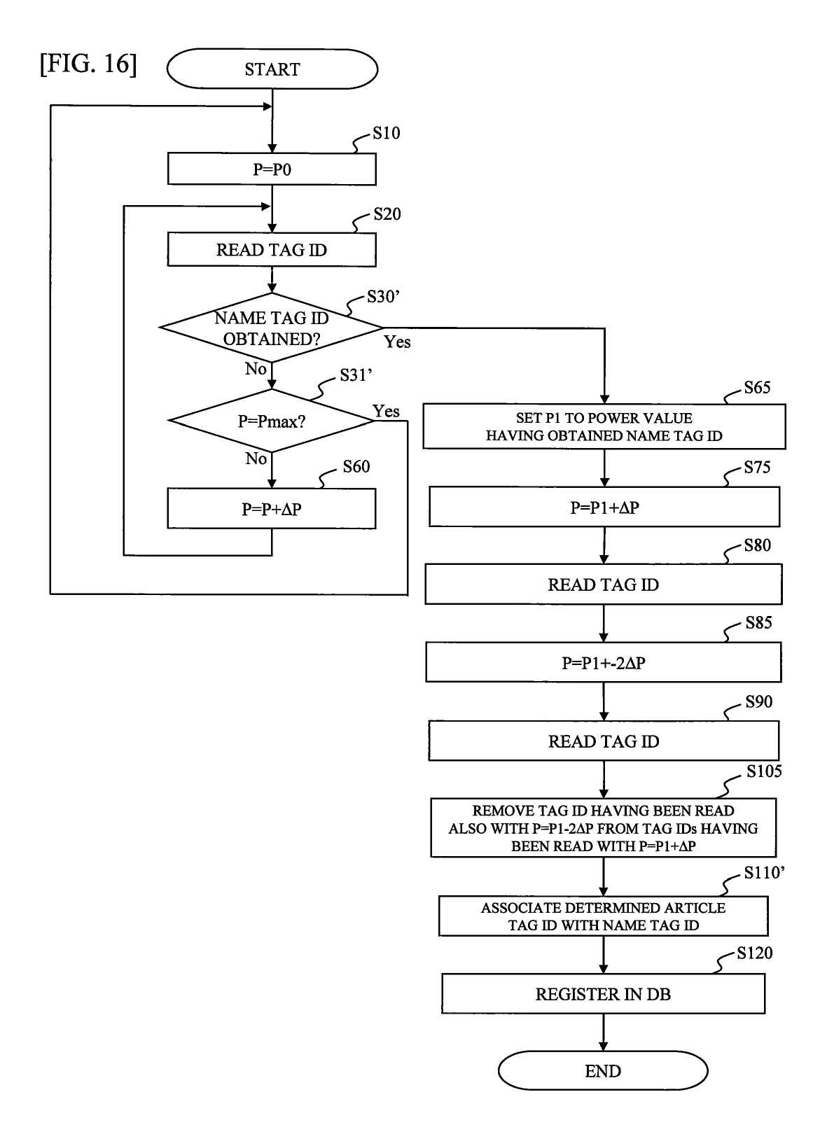

In order to execute what has been described above, the control circuit 202 of the reader 200 in the present modified example executes the control procedure shown in FIG. 16. The same symbols are assigned to the same steps as those in FIG. 14, and description of these steps will be omitted.

The steps S10 and S20 are similar to those in the flow shown in FIG. 14. That is, the power value P is set to the predetermined initial power value Po; radio communication with RFID tag circuit elements To-M, To-B is performed in ‘the first mode’; and tag IDs are read. Subsequently, the process moves to a newly arranged step S30′ corresponding to step S30.

In step S30′, the control circuit 202 determines whether or not a tag ID has been obtained in step S20 from the RFID tag circuit element To-M related to a name tag TM, corresponding to the reading signal. If a tag ID has not been obtained from an RFID tag circuit element To-M, the determination is not satisfied, and the process moves to step S31′. In step S31′, the control circuit 202 determines whether or not the power value P from the apparatus antenna 10 at this moment has reached the maximum power value Pmax. If not P=Pmax, namely P<Pmax, the determination is not satisfied, and the process moves to step S60. In step S60, the control circuit 202 increases the power value P by adding ΔP to the power value P, returns to step S20, and repeats the same procedure. If P=Pmax, the control circuit 202 returns to step S10, sets the power value P to the initial power value Po, and again performs the steps S20 and after.

In such a manner, until a tag ID is obtained from an RFID tag circuit element To-M, the control circuit 202 transmits the reading signal while sequentially increasing the power value P from Po by ΔP-by-ΔP. Then, when there is a response from an RFID tag circuit element To, the control circuit 202 determines whether the tag ID is the tag ID of the RFID tag circuit element To-M related to a name tag TM. Then, in a case where a tag ID has been obtained from an RFID tag circuit element To-M related to a name tag TM, the determination in step S30′ is satisfied, and the process moves to step S65.

In step S65, the control circuit 202 sets P1 to the power value at this moment, in other words, the minimum power value P that has enabled obtaining of a tag ID from the RFID tag circuit element To-M of a name tag TM in step S20.

Subsequently, in step S75, the mode of the reader 200 is changed to ‘the second mode’ described above. Then, the control circuit 202 sets the power from the apparatus antenna 10 to a power value P that is higher than or equal to the power value P1, namely P=P1+ΔP in the present example.

Then, in step S80, the control circuit 202 outputs a control signal to the transmitting portion 212 of the radio frequency circuit 201, similarly to step S20. As a result, reading signals for the above-described RFID tag circuit elements To are transmitted via the transmit-receive splitter 214 and the apparatus antenna 10, based on the power value P=P1+ΔP having been set in step S75. Then, response signals including tag IDs, the response signals having been transmitted from the RFID tag circuit elements To located in an area where communication is possible in response to the reading signal, are received by the control circuit 202 via the apparatus antenna 10 and the radio frequency circuit 201.

Subsequently, in step S85, the control circuit 202 sets the power from the apparatus antenna 10 to a power value P lower than the above-described power value P1, namely P=P1−2ΔP in the present example.

Then, in step S90, based on the power value P=P1−2ΔP having been set in step S85 and similarly to step S80, the control circuit 202 transmits a reading signal for the RFID tag circuit element To via the transmit-receive splitter 214 and the apparatus antenna 10. Then, a response signal including a tag ID, the response signal having been transmitted from the RFID tag circuit element To located in an area where communication is possible in response to the reading signal, is received by the control circuit 202 via the apparatus antenna 10 and the radio frequency circuit 201.

Then, the process moves to step S105, and as described above with reference to FIGS. 15A and 15B, the control circuit 202 removes the tag ID related to the RFID tag circuit element To-B having been obtained in step S90 from the tag IDs related to the RFID tag circuit elements To-B having been obtained in step S80, in other words, the overlap is deleted. In such a manner, the control circuit 202 determines the tag ID of an RFID tag circuit element To-B to be made associated with the tag ID of the RFID tag circuit element To-M related to the name tag TM having been obtained in step S20. This procedure executed by the control circuit 202 corresponds to a function as a determination portion.

Subsequently, in step S110′ newly arranged corresponding to step S110, the control circuit 202 associates the tag ID of the RFID tag circuit element To-B related to the article B, the tag ID having been determined in step S 105, with the tag ID of the RFID tag circuit element To-M related to the name tag TM, the tag ID having been obtained in ‘the first mode’ in step S20. This procedure executed by the control circuit 202 corresponds to a function as an association processing portion (refer to FIG. 15A).

Then, the process moves to step S120, which is similar to the above description, and the control circuit 202 outputs association information generated in the step S110′ via the communication line 208 to the server 207. As a result, the tag ID of the RFID tag circuit element To-M of the name tag TM and the tag ID of the RFID tag circuit element To-B of the article tag TB, which have been made associated with each other as described above, are registered and stored in the database DB, being associated with each other. Further, the server 207 creates or updates the corresponding record in the article management table in the database DB by the above-described method. Then, this flow terminates.

In the flow in FIG. 16, step S20 functions as a first obtaining portion set forth in the respective corresponding claims; step S80 functions as a second obtaining section; and step S90 functions as a third obtaining portion. These three steps function as an information obtaining portion in the present modified example.

Further, steps S60, S75, and S85 function as a power control portion.

In the modified example having been described above, the tag ID of the RFID tag circuit element To-B obtained in ‘the second power mode’ is, in step S110′, processed to be associated with the tag ID of the RFID tag circuit element To-M obtained in ‘the first power mode’. With this arrangement, similarly to the above-described embodiment, closeness between an RFID tag circuit element To-B and an RFID tag circuit element To-M, which occurs when a user M takes out an article B by hand or returns it, is detected. As a result, it is possible to manage the user M who takes out or returns the article B and the article B that is taken out or returned, associating the user M and the article B with each other with a simple control and a high accuracy.

Further, herein, subsequently to the detection of the position of the name tag TM in ‘the first power mode’, the mode is switched to ‘the second power mode’ to detect the article tag TB, which is in an adjacent area, and the tag ID of the RFID tag circuit element To-B is made associated with the tag ID of the RFID tag circuit element To-M. With this arrangement, differently from the above-described embodiment in which tag IDs are sequentially read while the power value P of the apparatus antenna 10 is monotonously increased, wasteful reading of tag IDs that are located at a position comparatively far from the RFID tag circuit element To-M can be avoided. Accordingly, energy saving and quick association processing can be attained.

(2) A case of using an up-and-down movable apparatus antenna:

In the above, the apparatus antenna 10 is a positionally-fixed antenna, however the present invention is not limited thereto. Concretely, a movable antenna, whose location can be changed, may be used. Such a modified example will be described below. The same symbols are assigned to the same parts as those in the above-described embodiment, and description of these parts will be omitted or briefed, as appropriate.

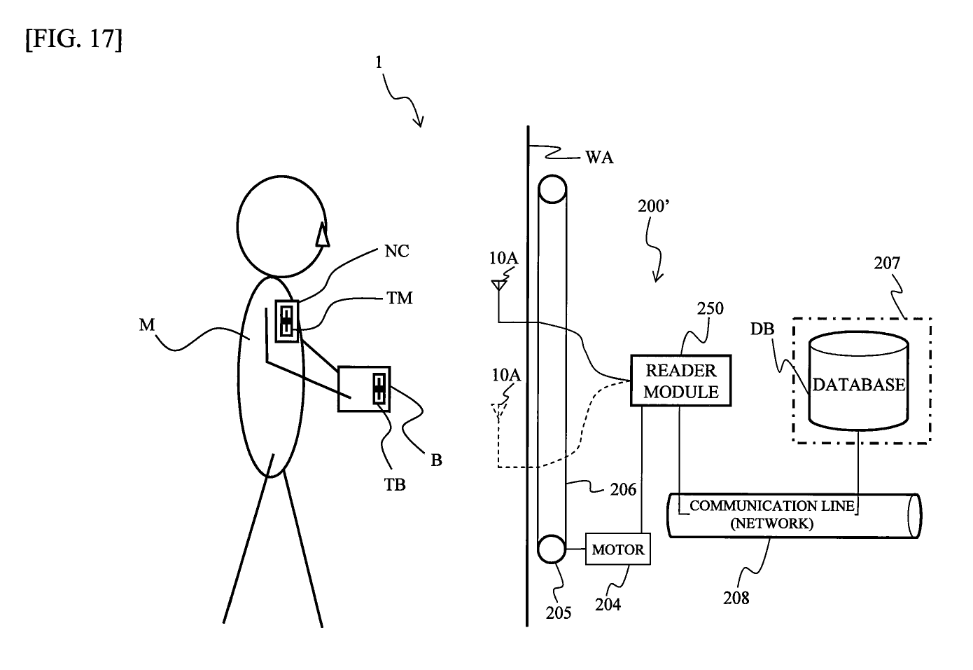

As shown in FIG. 17, for example, when the user M, who has the name card NC with an RFID tag circuit element To-M, is holding at hand the article B with an RFID tag circuit element To-B, the height position of the RFID tag circuit element To-M and the height position of the RFID tag circuit element To-B may be different. In a case where the height positions of two RFID tag circuit elements To-M, To-B are thus different, if radio communication is performed by the apparatus antenna 10 whose height position is fixed at one position, as in the above-described embodiment, the accuracy of corresponding relationship between the power of the apparatus antenna 10 and the distance from the reader 200 to an RFID tag circuit element To may drop.

Addressing this point, a reader 200′ in the present modified example is provided with a movable apparatus antenna 10A, up-and-down movable in the present example, whose position can be changed, by a motor for example, depending on ‘the first power mode’ and ‘the second power mode’ described above. That is, in the described above ‘first power mode’ aimed at obtaining a tag ID from an RFID tag circuit element To-M, the reader 200′ performs communication with the apparatus antenna 10A at a comparatively high position (refer to the solid line in FIG. 17) that is substantially the same height position as that of the name tag TM. In contrast, in ‘the second power mode’ aimed at obtaining a tag ID from an RFID tag circuit element To-B, the reader 200′ performs communication with the apparatus antenna 10A at a comparatively low position (refer to the dashed line in FIG. 17) that is substantially the same height position as that of the article tag TB.

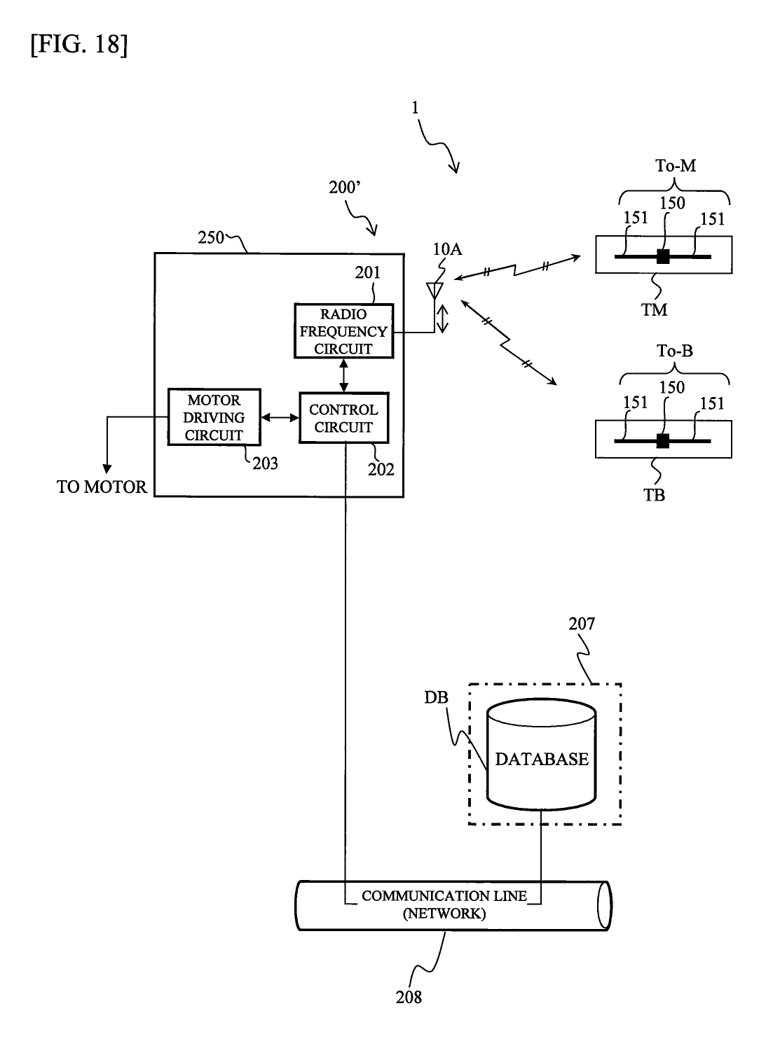

Except this point, the reader 200′ has, as shown in FIG. 18, almost the same function as that of the reader 200 in the above-described embodiment. Concretely, the reader 200′ includes a reader module 250, the apparatus antenna 10A, a motor 204, a belt 206, and a pulley 205.

The reader module 250 is a primary element configured to execute a radio communication function and has almost the same functions as those of the parts of the reader 200 in the above-described embodiment, except the apparatus antenna 10. However, differently from the reader 200 in the above-described embodiment, the reader module 250 additionally has a motor driving circuit 203 described later. Further, the reader module 250 includes the radio frequency circuit 201 and the control circuit 202 having almost the same functions as those of the reader 200 in the above-described embodiment, and the motor driving circuit 203 configured to drive the motor 204. The apparatus antenna 10A is installed to replace the apparatus antenna 10 of the reader 200. The motor 204 generates a driving force under control by the motor driving circuit 203. The pulley 205 transfers rotation to the belt 206 configured to transfer the driving force.

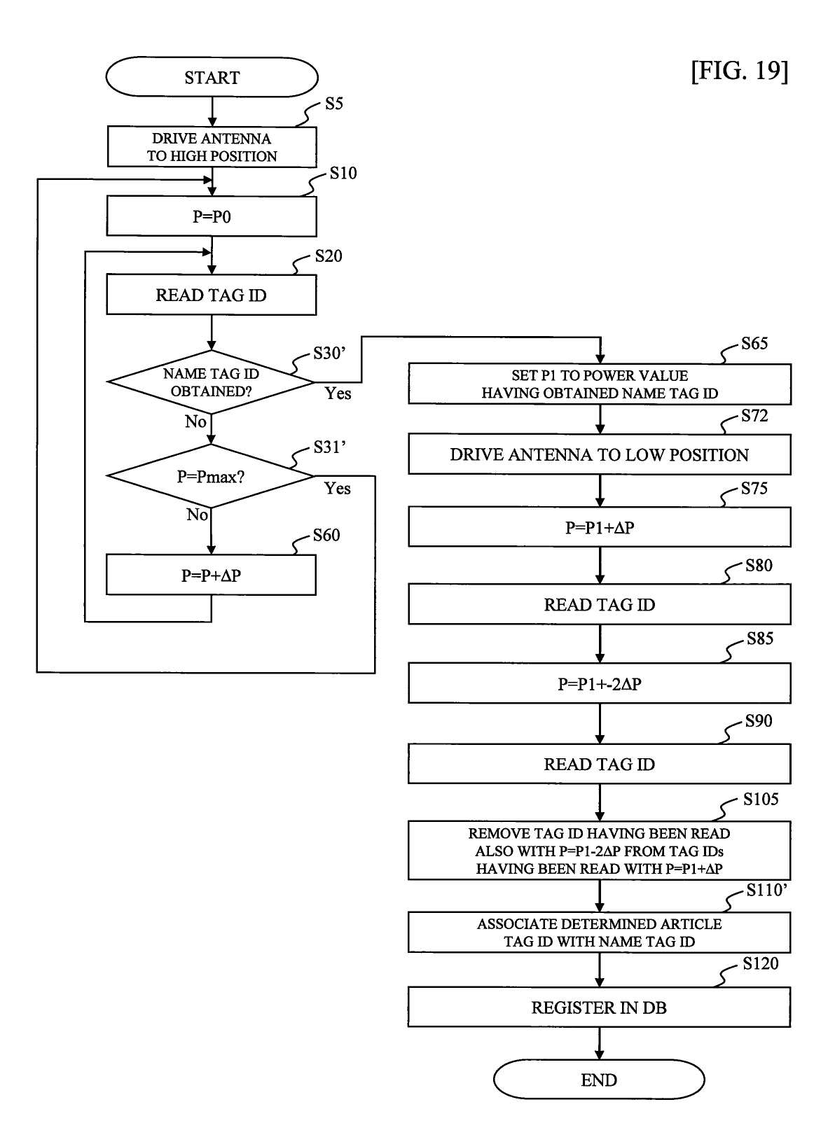

In the present modified example, the control circuit 202 of the reader 200′ executes the control procedure shown in FIG. 19. In FIG. 19, the same symbols are assigned to the same steps as those in FIGS. 14 and 16, and description of them will be omitted.

First, in newly arranged step S5, the control circuit 202 outputs a control signal to the motor driving circuit 203. As a result, the apparatus antenna 10A is driven, via the motor 204, the pulley 205, and the belt 206, to a height position almost the same as that of the RFID tag circuit element To-M, namely the position shown by the solid line in FIG. 17.

Subsequent steps, which are step S10, step S20, step S30′, step S31′, step S60, and step S65, are the same as those in above-described FIG. 16. That is, a power value P is set to a predetermined initial power value Po; radio communication with RFID tag circuit elements To is performed in ‘the first power mode’ described above; and reading of tag IDs is performed. Until a tag ID is obtained from a response signal from an RFID tag circuit element To-M, transmission of a reading signal is repeated while adding ΔP to the power value P. When a tag ID has been obtained from an RFID tag circuit element To-M, the control circuit 202 sets P1 to the power value P then. Subsequently, the process moves to newly arranged step S72.

In step S72, the control circuit 202 outputs a control signal to the motor driving circuit 203. As a result, via the motor 204, the pulley 205, and the belt 206, the apparatus antenna 10A is driven to a height position that is approximately the same as that of the RFID tag circuit element To-B, namely the position shown by the dashed line in FIG. 17.

The subsequent procedure from and after step S75 is the same as that in FIG. 16, and description will be omitted.

According to the present modified example, in ‘the first power mode’, communication is performed in a state that the apparatus antenna 10A becomes approximately at the same height position as that of the RFID tag circuit element To-M, in other words, in a state that the communication distance is approximately equal to the horizontal distance. In ‘the second power mode’, the apparatus antenna 10A moves down into a state that the height position is approximately the same as that of the RFID tag circuit element To-B, and thus communication can be performed in a state that the communication distance is approximately equal to the horizontal distance. With this arrangement, the accuracy of corresponding relationship, as described above, between the power from the radio frequency circuit 201 and the apparatus antenna 10 and the distance from the reader 200 to the RFID tag circuit elements To-M, To-B can be excellently maintained.

Incidentally, although, the height position of one apparatus antenna 10A has been changed as described above, the present invention is not limited thereto. That is, two antennas at different installation positions, namely a first antenna and a second antenna, may be used by switching.

In this case, for example, in ‘the first power mode’, communication is performed by the use of the first antenna that is at a height position being approximately the same as that of the RFID tag circuit element To-M and makes the communication distance approximately equal to the horizontal distance. In ‘the second power mode’, communication is performed by the use of the second antenna that is at a height position being a little lower and approximately the same as that of the RFID tag circuit element To-B and makes the communication distance approximately equal to the horizontal distance. With this arrangement, effects, which are similar to the above, can be obtained.

(3) A case of adjusting the increase or decrease width of power in the second power mode, corresponding to the number of obtained tag IDs:

That is, for example, when a tag ID from an RFID tag circuit element To-M has been obtained, the mode is subsequently changed from ‘the first power mode’ to ‘the second power mode’. After the change, when the number of tag IDs having been obtained with a power value higher than the power value P1, namely P1+ΔP in the above-described example, is too large, it is possible that the tag IDs of RFID tag circuit elements To-B other than the tag ID of a targeted RFID tag circuit element To-B to be associated have been obtained, in other words, it is possible that the increase width of the power is too large. In this case, in the present modified example, by setting ‘n’ to an appropriate number (similarly hereinafter), the power is changed to a power a little lower than the above-described power value P of this moment, for example, to the power value P subtracted by ΔP/n, and obtaining tag IDs is again performed with a communication area narrowed to the name tag TM side.

In reverse, when the number of tag IDs having been obtained with the above-described power value P1+ΔP is too small, it is possible that the tag ID of a targeted RFID tag circuit element To-B to be associated has not been obtained. In this case, in the present modified example, the power is changed to a power a little higher than the above-described power value P of this moment, for example, to the power value P added with ΔP/n, and obtaining tag IDs is again performed with a communication area enlarged to the side opposite to the name tag TM.

Further, similarly to the above, after the mode is changed to ‘the second power mode’ and obtaining tag IDs is performed with a power value higher than the power value P1, a case may occur where the number of tag IDs obtained with a lower power value than the power value P1, P1−2ΔP for example, is too large. In this case, in the present modified example, it is possible that the tag IDs of RFID tag circuit elements other than a targeted RFID tag circuit element to be associated have been obtained. In this case, by setting ‘m’ to an appropriate number (similarly hereinafter), the power is changed to a power a little higher than the power value P of this moment, for example, to the power P added with ΔP/m, and obtaining tag IDs is again performed with a communication area narrowed to the name tag TM side.

In reverse, when the number of tag IDs having been obtained with the above-described power value P1−2ΔP is too small, it is possible that the tag ID of a targeted RFID tag circuit element To-B to be associated has not been obtained. In this case, in the present modified example, the power is changed to a power a little lower than the power value P of this moment, for example, to the power value P subtracted by ΔP/m, and obtaining tag IDs is again performed with a communication area enlarged to the side opposite to the name tag TM.

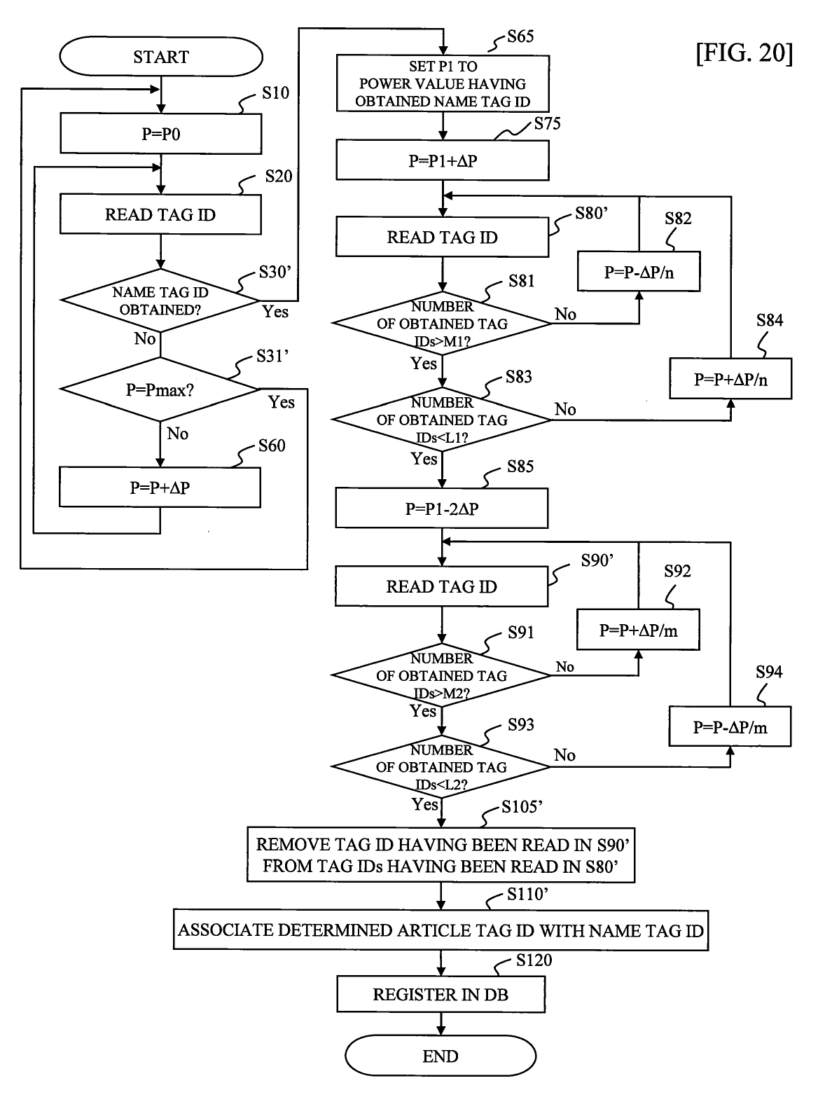

The control circuit 202 of the reader 200 in the present modified example executes the control procedure shown by the flow in FIG. 20. FIG. 20 corresponds to FIGS. 14, 15, and 19. The same symbols will be assigned to the same steps as those in FIG. 16, and the description of them will be omitted.

Step S10, step S20, step S30′, step S31′, step S60, step S65, and step S75 are similar to those in the flow shown in FIG. 16. That is, the power value P is set to the predetermined initial power value Po; radio communication with RFID tag circuit elements To is performed in ‘the first power mode’; and reading of tag IDs is performed. Transmission of the reading signal is repeated while adding ΔP to the power value P until a response signal is received from an RFID tag circuit element To-M. When a tag ID has been obtained from an RFID tag circuit element To-M, the control circuit 202 changes the mode to ‘the second power mode’ while setting P1 to the power value P then, and sets the power to P1+ΔP. Subsequently, the process moves to step S80′ having been newly arranged, corresponding to step S80.

In step S80′, similarly to step S20, the control circuit 202 outputs a control signal to the transmitting portion 212 of the radio frequency circuit 201. As a result, based on the power value P having been set in step S75, in later-described step S82, or in later-described step S84, a reading signal for the RFID tag circuit element To is transmitted via the transmit-receive splitter 214 and the apparatus antenna 10. Then, via the apparatus antenna 10 and the radio frequency circuit 201, the control circuit 202 receives a response signal including a tag ID having been transmitted, in response to the reading signal, from the RFID tag circuit element To disposed at a position in an area where communication is possible.

Subsequently, in step S81, the control circuit 202 determines whether or not the number of tag IDs having been obtained from RFID tag circuit elements To in step S80′ is larger than a predetermined threshold M1. If the number of tag IDs having been obtained is smaller than or equal to the predetermined threshold M1, the determination is not satisfied, and the process moves to step S82. In step S82, the control circuit 202 subtracts ΔP/n from the set value of the power value P. Subsequently, the process returns to step S80′, and repeats the same procedure. On the other hand, if the number of tag IDs having been obtained in step S80′ is greater than the predetermined threshold Ml, the determination is satisfied, and the process moves to step S83.

In step S83, the control circuit 202 determines whether or not the number of tag IDs having been obtained from RFID tag circuit elements To in step S80′ is smaller than a predetermined threshold L1. If the number of tag IDs having been obtained is larger than or equal to the predetermined threshold L1, the determination is not satisfied, and the process moves to step S84. In step S84, the control circuit 202 adds ΔP/n to the set value of the power value P. Subsequently, the process returns to step S80′, and repeats the same procedure. On the other hand, if the number of tag IDs having been obtained in step S80′ is smaller than the predetermined threshold L1, the determination in step S83 is satisfied, and the process moves to step S85.

In step S85, the control circuit 202 sets the power of the apparatus antenna 10 to P=P1−2ΔP, similarly to FIG. 16. Subsequently, the process moves to step S90′ having been newly arranged, corresponding to step S90.

In step S90′, the control circuit 202 outputs a control signal to the transmitting portion 212 of the radio frequency circuit 201, similarly to step S20. As a result, based on the power value P having been set in above-described step S85, later-described step S92, or in later-described step S94, a reading signal for the RFID tag circuit element To is transmitted via the transmit-receive splitter 214 and the apparatus antenna 10. Then, via the apparatus antenna 10 and the radio frequency circuit 201, the control circuit 202 receives a response signal including a tag ID having been transmitted, in response to the reading signal, from the RFID tag circuit element To disposed at a position in an area where communication is possible.

Subsequently, in step S91, the control circuit 202 determines whether or not the number of tag IDs having been obtained from RFID tag circuit elements To in step S90′ is larger than a predetermined threshold M2. If the number of tag IDs having been obtained is smaller than or equal to the predetermined threshold M2, the determination is not satisfied, and the process moves to step S92. In step S92, the control circuit 202 adds ΔP/m to the set value of the power value P. Subsequently, the process returns to step S90′, and repeats the same procedure. On the other hand, if the number of tag IDs having been obtained in step S90′ is larger than the predetermined threshold M2, the determination in step S91 is satisfied, and the process moves to step S93.

In step S93, the control circuit 202 determines whether or not the number of tag IDs having been obtained from RFID tag circuit elements To in step S90′ is smaller than a predetermined threshold L2. If the number of tag IDs having been obtained is greater than or equal to the predetermined threshold L2, the determination is not satisfied, and the process moves to step S94. In step S94, the control circuit 202 subtracts ΔP/m from the set value of the power value P. Subsequently, the process returns to step S90′, and repeats the same procedure. On the other hand, if the number of tag IDs having been obtained in step S90′ is smaller than the predetermined threshold L2, the determination in step S93 is satisfied, and the process moves to step S105′ having been arranged, corresponding to step S 105.

In step S105′, the control circuit 202 subtracts the tag IDs which have satisfied the determination in step S93, in other words, the tag IDs having been obtained in the immediately previous step S90, from the tag IDs having satisfied the determination in step S83, in other words, the tag IDs having been obtained in the immediately previous step S80. That is, the control circuit 202 deletes the overlapped tag IDs. Subsequently, the control circuit 202 determines the tag ID of an RFID tag circuit element To-B to be associated with the tag ID of the RFID tag circuit element To-M related to the name tag TM having been obtained in step S20. This procedure executed by the control circuit 202 corresponds to a function as a determination portion.

The subsequent steps from and after step S110′ are similar to those in above-described FIG. 16, and description of them will be omitted.

In the above, step S80′ functions as a second obtaining portion set forth in respective claims, step S90′ functions as a third obtaining portion, and these steps and step S20 function as an information obtaining portion. Further, step S60, step S82, step S84, step S92, and step S94 function as a power control portion.

According to the present modified example, as has been described above, in ‘the second power mode’, based on the largeness or smallness of the number of tag IDs having been obtained from RFID tag circuit elements To, more specifically, by comparison with the thresholds M1, L1, M2, and L2, the power is subjected to further adjustment by increasing or decreasing, and the obtaining of tag IDs is again performed. With this arrangement, the RFID tag circuit element To-B disposed on an article B that a user M is taking out or returning can be further reliably detected.

(4) A case where another name tag is present in the vicinity:

That is, in the present modified example, after a tag ID is obtained from an RFID tag circuit element To-M related to one name tag TM, whether or not another name tag TM is present in the vicinity is searched for confirmation. If another name tag TM is present in the vicinity, then notification of the presence is made.

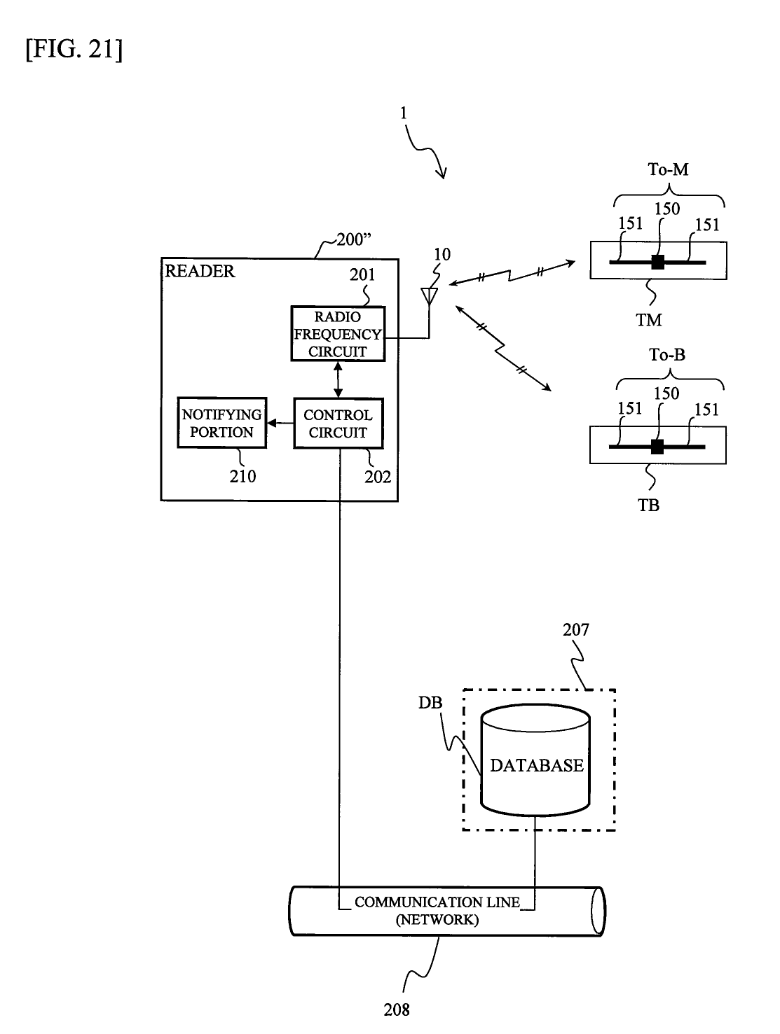

As shown in FIG. 21 corresponding to above-described FIGS. 2 and 18, a reader 200″ in the present modified example newly includes a notification part 210 as a notification device, in addition to the radio frequency circuit 201, the control circuit 202, and the apparatus antenna 10. In FIG. 21, the same symbols are assigned to the same parts as those in FIG. 2, and description will be omitted or briefed, as appropriate. When a tag ID has been obtained from another RFID tag circuit element To-M, as described above, the notification part 210 supplies notification to an operator, not shown, upon input of a control signal from the control circuit 202, for example, sound, light, or vibration.

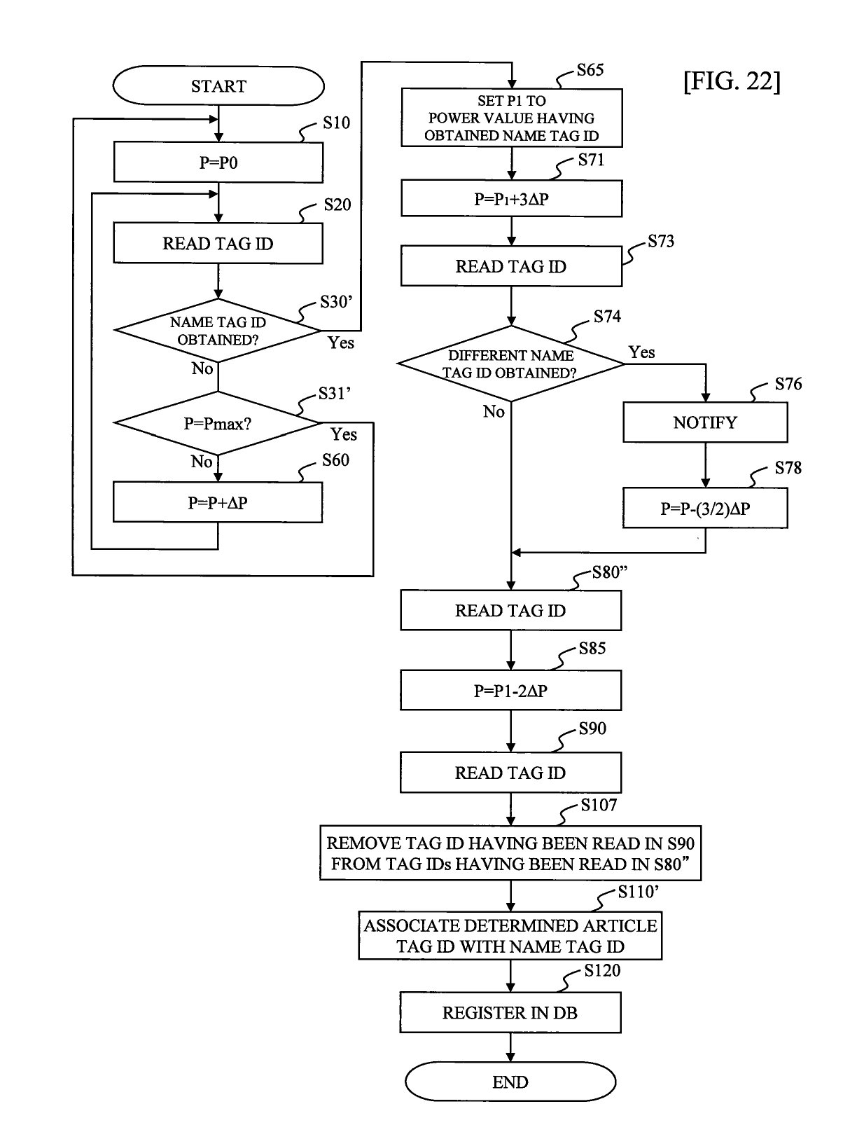

Further, when, as described above, the reader 200″ in the present modified example has obtained a tag ID from an RFID tag circuit element related to another name tag TM, the reader 200″ resets the power and again obtains a tag ID from an RFID tag circuit element To-B related to an article B. The control circuit 202 of the reader 200″ executes the control procedure shown by the flow in FIG. 22. FIG. 22 corresponds to above-described figures including FIG. 16. The same symbols are assigned to the same steps as those in FIG. 16, and description will be omitted.

Step S10, step S20, step S30′, step S60, and step S65 are the same as those in the flow shown in above-described FIG. 16, and description will be omitted. In step S65, the control circuit 202 sets P1 to the minimum power value P. Subsequently, the process moves to the newly arranged step S71.

In step S71, similarly to above-described step S75, in order to obtain a tag ID from an RFID tag circuit element To-B related to an article tag TB, the control circuit 202 sets the power from the apparatus antenna 10 to a power value P that is the seventh power value higher than the power value P1. Incidentally, the power value P1 is the power at the time when the tag ID has been obtained from an RFID tag circuit element To-M related to one name tag TM. In the present example, the power value P is set, differently from the above, to P=P1+3ΔP as a value higher than the power value P1.

Then, in step S73, similarly to step S20, the control circuit 202 outputs a control signal to the transmitting portion 212 of the radio frequency circuit 201. As a result, based on the power value P=P1+3ΔP having been set in step S73, the transmitting portion 212 transmits a reading signal via the transmit-receive splitter 214 and the apparatus antenna 10 to RFID tag circuit elements To. Then, a response signal, transmitted from the RFID tag circuit element To located in an area where communication is possible in response to the reading signal and including a tag ID, is received by the control circuit 202 via the apparatus antenna 10 and the radio frequency circuit 201.

Subsequently, the process moves to step S74, and the control circuit 202 determines whether or not the tag ID of an RFID tag circuit element To-M, which is different from the RFID tag circuit element To-M whose tag ID having been obtained in step S20, is included in tag IDs having been obtained in step S73. If a tag ID has not been obtained from a different RFID tag circuit element To-M, the determination is not satisfied, and the mode changes to the second power mode, while the power value P=P1+3ΔP is unchanged. Subsequently, the process moves to step S80″ having been newly arranged corresponding to step S80.

On the other hand, in step S74, if a tag ID has been obtained from a different RFID tag circuit element To-M, the determination in step S74 is satisfied, and the process moves to step S76.

In step S76, the control circuit 202 outputs a control signal to the notification part 210. As a result, a notification corresponding to the control signal, sound for example, is supplied to an operator. Subsequently, the process moves to step S78.

In step S78, the mode of the reader 200 changes to the second power mode. The control circuit 202 subtracts an appropriate value from the set value of the power value P to change the power value P=P1+3ΔP having been set in step S71 to a lower value. In the present example, the control circuit 202 subtracts (3/2)ΔP to remove a half from the area, where communication is possible, having been enlarged toward the direction going away from the name tag TM by adding 3ΔP to the power value P1 in step S71. That is, a control is performed such as to reduce the enlarged area, where communication is possible, to the half of it. In other words, the control circuit 202 narrows and limits the area where article tag TBs can be detected so that the area does not include the position of presence of the above-described another RFID tag circuit element To-M, the position corresponding to the power value P1+3ΔP. Subsequently, the process moves to step S80″.

In step S80″, the control circuit 202 outputs a control signal to the transmitting portion 212 of the radio frequency circuit 201, similarly to step S80′. As a result, based on the power value P having been set in Step S71 or step S78, a reading signal is transmitted via the transmit-receive splitter 214 and the apparatus antenna 10 to the RFID tag circuit element To. Then, a response signal, transmitted from the RFID tag circuit element To located in an area where communication is possible in response to the reading signal and including a tag ID, is received by the control circuit 202 via the apparatus antenna 10 and the radio frequency circuit 201. This procedure executed by the control circuit 202 corresponds to a function as the second obtaining portion. Incidentally, step S80″, above-described step S20 and step S90 function as the information obtaining portion in the present modified example.

Subsequent step S85 and step S90 are similar to those in above-described FIG. 16, wherein the power from the apparatus antenna 10 is set to P1−2ΔP, and when tag IDs have been read by radio communication with RFID tag circuit elements To, the process moves to step S107 having been newly arranged.

In step S107, the control circuit 202 subtracts tag IDs related to RFID tag circuit elements To-B having been obtained in step S90 from tag IDs related to RFID tag circuit elements To-B having been obtained in step S80″. As a result, the control circuit 202 determines the tag ID of an RFID tag circuit element To-B to be associated with the tag ID of the RFID tag circuit element To-M related to the name tag TM having been obtained in step S20. This procedure executed by the control circuit 202 corresponds to a function as a determination portion.

The subsequent steps S110′ and after are similar to those in above-described FIG. 16, and description will be omitted.

In the above, step S60, step S71, step S78, and step S85 function as a power control portion set forth in respective claims.

As has been described above, in the present modified example, after a tag ID is obtained from one RFID tag circuit element To-M, further obtaining of a tag ID from another RFID tag circuit element To-M is tried. For this purpose, in step S71, the control circuit 202 resets the power value of the apparatus antenna 10 to a higher value than the minimum power value having enabled obtaining a tag ID from the first RFID tag circuit element To-M. With this arrangement, when a tag ID has been obtained from one RFID tag circuit element To-M to be a reference for association processing and this RFID tag circuit element To-M has been found, it is subsequently possible to confirm whether or not another RFID tag circuit element To-M is further present in the communication area of the apparatus antenna 10 before trying to associate an RFID tag circuit element To-B that corresponds to the former RFID tag circuit element To-M.

Then, if a tag ID has been obtained from another RFID tag circuit element To-M, the notification part 210 performs in step S76 notification to the operator, such as sound, light, vibration. As a result, the operator is ensured to recognize that a plurality of name tag TMs to be a reference for association of an ID tag circuit element To-B related to an article tag TB are present in the communication area of the apparatus antenna 10. As a result, in order to correctly perform associating, it is possible to take measures, for example, to ask the user M holding the another name tag TM to go away so that the name tag TM gets out of the communication range of the apparatus antenna 10.

Further, particularly, when a tag ID has been obtained from another RFID tag circuit element To-M with the power having been reset as described above, the area, where the RFID tag circuit element To-B being the target of associating is present, can be narrowed and limited to the apparatus antenna 10 side from the another RFID tag circuit element To-M, and then detection of tag ID is performed. With this arrangement, it is possible to reliably associate the RFID tag circuit element To-B, which is present in the narrowed and limited area, with the one RFID tag circuit element To-M to be a reference of association processing.

Incidentally, the method of ‘confirming whether or not another name tag TM is present, and if a presence is found, limiting the search area for an article tag TB thereafter’, the method having been described with reference to step S72, step S76, and step S78 for example, can be applied also to the embodiment described above with reference to FIGS. 1 to 14. In this case, this arrangement can be attained by, in steps S70 and after in FIG. 14, checking whether no tag ID of an RFID tag circuit element To-M related to another name tag TM has been obtained and stored in the nonvolatile memory 202E other than the RFID tag circuit element To-M related to the name tag TM, having been detected in step S70, to be a reference for associating. If a presence of another RFID tag circuit element To-M has been detected, this arrangement can be attained by, similarly to the above, limiting the area, where the article tag TB to be associated with the name tag TM to be a reference for the associating, so that the area does not include the another name tag TM.

(5) A case of installing an apparatus antenna near the feet of a user:

In the above arrangement, although, the apparatus antennas 10, 10A of the readers 200, 200′, and 200″ are installed on a wall WA, the present invention is not limited thereto, and these antennas may be installed near the feet of the user M.

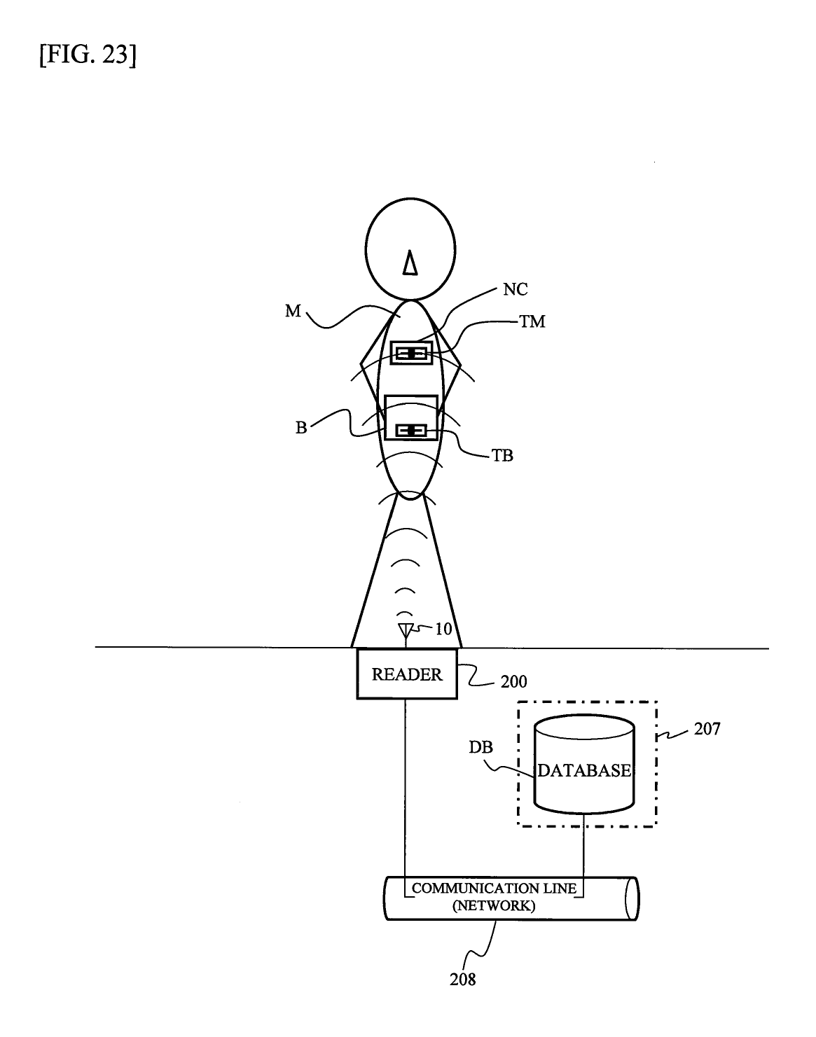

FIG. 23 corresponds to above-described FIG. 1. The same symbols are assigned to the same parts as those in FIG. 1, and description will be omitted or briefed, as appropriate.

As FIG. 23 shows, in general, it tends to be that when a user M takes out or returns an article B, the user holds the article B by hand at a height between the waist and the chest. Accordingly, in the present modified example, an RFID tag circuit element To-B having been detected with a power value P in a certain area, for example, from P=P1−ΔP to a power value P that substantially corresponds to the height of the chest of the user M, P=P1 for example, is extracted.

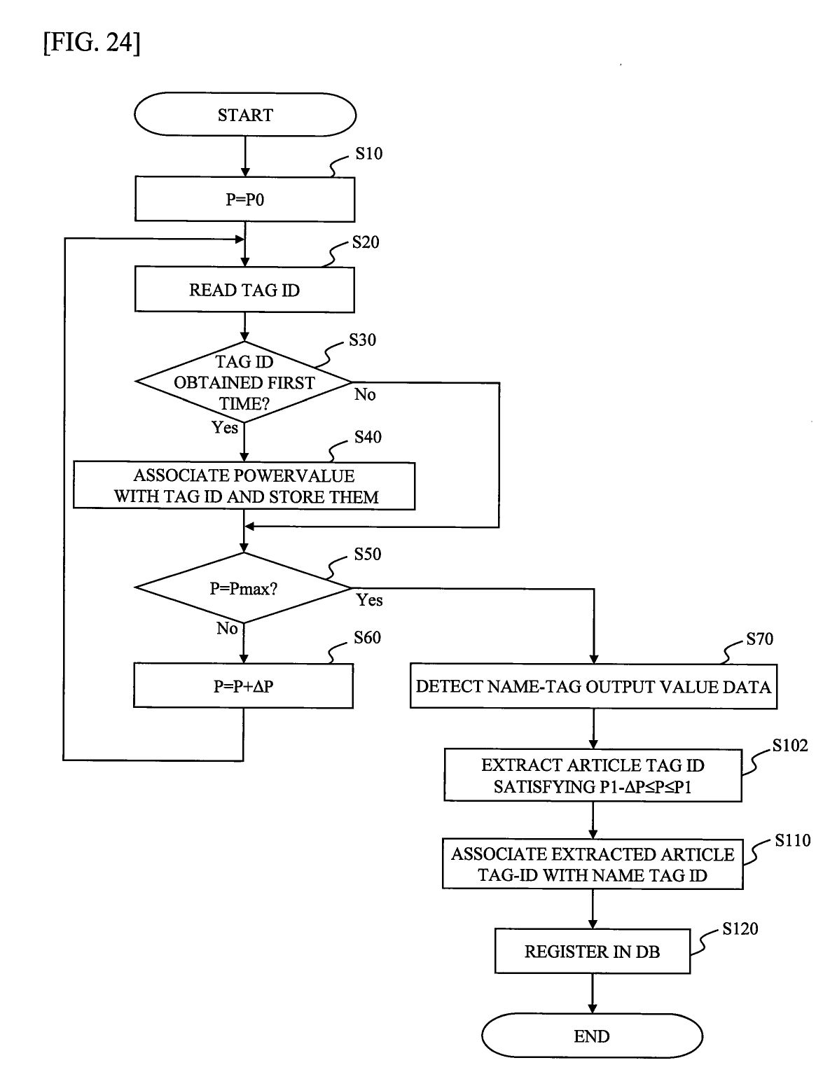

When the user M takes out or returns the article B, the user M passes above the apparatus antenna 10 of the reader 200 installed, for example, on the floor. As a result, information on the RFID tag circuit element To-B disposed on the article tag TB of the article B and information on the RFID tag circuit element To-M disposed on the name tag TM of the name card NC are read. The control circuit 202 of the reader 200 in the present modified example executes the control procedure shown in FIG. 24. FIG. 24 corresponds to figures used in the above-described embodiment including FIG. 14. The same symbols are assigned to the same steps as those in FIG. 14, and description will be omitted.

In FIG. 24, the difference from FIG. 14 is that step S102 is executed instead of step S100 in FIG. 14. That is, in step S70, when the nonvolatile memory 202E has been accessed and the output data for the name tag at the time when the tag ID of the RFID tag circuit element To-M disposed on a name tag TM has been obtained for the first time, the process moves to newly arranged step S102.

In step S102, the control circuit 202 accesses the nonvolatile memory 202E, and, similarly to step S70, all the data, which have been sequentially stored in step S40 and in which the tag IDs of RFID tag circuit elements To and the power values P are related with each other, are referred to. Then, based on the name tag power value data obtained in step S70, the control circuit 202 extracts the tag ID of an RFID tag circuit element To-B related to an article B, for which the corresponding power value P is present in a certain area, P1−ΔP≦P≦P1 in the present example as described above, on the side that includes the power value P1 and is lower than this P1. This procedure executed by the control circuit 202 corresponds to a function as an extraction portion.

The subsequent steps from step S110 and after are similar to those in above-described FIG. 14, and description of them will be omitted.

According to the present modified example, in a case where the apparatus antenna 10 is installed at the feet of a user M, similarly to the above, closeness between an RFID tag circuit element To-B and an RFID tag circuit element To-M, which occurs when the user M takes out or returns an article B by hand, can be detected. As a result, the user M who takes out or returns and the article B taken out or returned can be associated with each other with a simple control and accuracy for management.

Further, in the above description, using the arrangement where the apparatus antenna 10 is installed at the feet of the user M, the power sequentially changes until the power value P reaches the maximum power value Pmax. Then, a tag ID is obtained from an RFID tag circuit element To-M related to a name tag TM and an RFID tag circuit element To-B related to an article B is obtained. That is, in the above, description has been made, taking an example of a case of executing the method in the above-described embodiment. However, the present invention is not limited thereto. That is, similarly to the modified example (1), arrangement may be made such as to first obtain a tag ID from an RFID tag circuit element To-M related to a name tag TM while sequentially changing the power value P of the apparatus antenna 10, and then obtain a tag ID from an RFID tag circuit element To-B of an article B in an area in the vicinity of the name tag TM while further changing the power, for example, decreasing. Or, the methods in above-described (2) to (4) may be executed.

### (6) Others:

For example, when an RFID tag circuit elements To-M are disposed on name cards NC or ID cards, there are cases where the communication distance is set short, in other words, the communication sensitivity is set low in the point of view of protection of personal information. In contrast, there are cases where, for RFID tag circuit elements To-B, which are free from such a problem, the communication distance is set longer, in other words, the communication sensitivity is set higher than those for the RFID tag circuit elements To-M. In such a manner, if communication sensitivities are different, the distances to which communication is possible are different, even with the same power value from the apparatus antenna 10. As a result, the correspondence relationship between the power of the apparatus antenna 10 and the area where communication is possible from the reader 200 to the RFID tag circuit elements To-M, To-B, in other words, the maximum communication distance may be affected.

In addressing this point, as the power value P used in the above-described embodiment or in the modified examples (1) to (4), a power value P′ corrected by a sensitivity coefficient C may be used, wherein the power value P′ reflects the difference between the communication sensitivity for communication between an apparatus antenna and an RFID tag circuit element To-M and the communication sensitivity for communication between the apparatus antenna and an RFID tag circuit element To-B. That is, a power value P′=C×P obtained by multiplying the power value P by a sensitivity coefficient C may be used.

With this arrangement, even in a case where there is a difference in the communication sensitivity, due to the difference in the type, function, or purpose of RFID tag circuit elements To-M, To-B, as described above, it is possible to obtain a tag ID of an RFID tag circuit element To-B that is present in an area in the vicinity of an RFID tag circuit element To-M, with a high accuracy.

Incidentally, the arrows shown in FIGS. 3 and 4 show an example of the flow of a signal, and does not limit the flow direction of a signal. Further, the flowcharts shown in figures including FIGS. 14, 16, 19, 20, 22, and 24 do not limit the present invention to the procedures shown in these flows, and changes and modifications, such as addition, deletion of steps or a change in the sequence may be made without departing from the spirit and concept of the present invention.

Further, in addition to the above, the methods according to the above-described embodiment and the respective modified examples may be used in an appropriate combination.

In addition, though not described in detail, various changes and modifications can be added in embodiments of the present invention without departing from the spirit of the present invention.

What is claimed is:

1. An apparatus for communicating with a radio frequency identification (RFID) tag, comprising:
an apparatus antenna device configured to perform radio communication with a plurality of RFID tag circuit elements, the RFID circuit elements each having an IC circuit part configured to store information and a tag antenna capable of transmission and reception of information, and including a first RFID tag circuit element and a second RFID tag circuit element;
a power control portion capable of changing power of said apparatus antenna device;
an information obtaining portion configured to obtain information via said apparatus antenna device from said first RFID tag circuit element to be a reference for association processing and said second RFID tag circuit element being an object of association with said first RFID tag circuit element, based on said power controlled by said power control portion; and
an association processing portion configured to perform said association processing of tag identification information of said second RFID tag circuit element with tag identification information of said first RFID tag circuit element, based on a result of comparison between a power value of said apparatus antenna device when said information obtaining portion has obtained information from said second RFID tag circuit element and a power value of said apparatus antenna device when said information obtaining portion has obtained information from said first RFID tag circuit element.

2. The apparatus according to claim 1, further comprising:
a storage processing portion configured to store plural pieces of said tag identification information that said information obtaining portion has obtained by said obtaining of information from said first RFID tag circuit element or said second RFID tag circuit element while said power control portion has sequentially changed said power of said apparatus antenna device, wherein said storage processing portion associates said plural pieces of said tag identification information with respective corresponding values of said power;
a detection portion configured to detect said tag identification information of sad first RFID tag circuit element and a corresponding first power value, based on storage content in said storage processing portion; and
an extraction portion configured to extract, from said plural pieces of tag identification information stored in said storage processing portion, tag identification information of said second RFID tag circuit element for which a corresponding power value is present in a certain area, the area including said first power value and extending from a second power value to a third power value, wherein
said association processing portion performs association processing of said tag identification information extracted by said extraction portion with said tag identification information of said first RFID tag circuit element.

3. The apparatus according to claim 1, wherein:
said power control portion has:
a first power mode that sequentially changes said power of said apparatus antenna device in order to obtain said tag identification information from said first RFID tag circuit element by said information obtaining portion; and
a second power mode that further changes said power of said apparatus antenna device after said information obtaining portion has obtained said tag identification information from said first RFID tag circuit element in said first power mode, in order to obtain said tag identification information from said second RFID tag circuit element by said information obtaining portion, wherein
said association processing portion performs association processing of said tag identification information of said second RFID tag circuit element that said information obtaining portion has obtained in said second power mode, with said tag identification information of said first RFID tag circuit element.

4. The apparatus according to claim 3, wherein:
said information obtaining portion comprises:
a first obtaining portion configured to obtain said tag identification information from said first RFID tag circuit element while said power control portion sequentially increases said power of said apparatus antenna device in said first power mode;
a second obtaining portion configured to, at a condition that a minimum power that has enabled obtaining said tag identification information from said first RFID tag circuit element by said first obtaining portion is set a fourth power value and when said power control portion has set a fifth power value of said apparatus antenna device to a power value that is higher than or equal to said fourth power value in said second power mode, obtain said tag identification information from said second RFID tag circuit element that is capable of communicating with said fifth power value; and
a third obtaining portion configured to, when said power control portion has set a sixth power value of said apparatus antenna device to a power value that is lower than said fourth power value in said second power mode, obtain said tag identification information from said second RFID tag circuit element that is capable of communication with said sixth power value, wherein
said apparatus further comprises a determination portion configured to determine said tag identification information to be subjected to said association processing, removing the part that said tag identification information having been obtained by said second obtaining portion overlap said tag identification information having been obtained by said third obtaining portion, from the tag identification information having been obtained by said third obtaining portion, and wherein
said association processing portion performs association processing of said tag identification information determined by said determination portion with said tag identification information of said first RFID tag circuit element.

5. The apparatus according to claim 2, wherein:
said extraction portion uses power values corrected with a sensitivity coefficient that reflects a difference between a communication sensitivity for said first RFID tag circuit element and a communication sensitivity for said second RFID tag circuit element, as said second power value and said third power value,
or
said second obtaining portion and said third obtaining portion of said information obtaining portion use power values corrected with said sensitivity coefficient that reflects said difference between said communication sensitivity for said first RFID tag circuit element and said communication sensitivity for said second RFID tag circuit element, as said fifth power value and said sixth power value.

6. The apparatus according to claim 4, wherein:
in a case where a number of pieces of said tag identification information that said second obtaining portion has obtained with said fifth power value is relatively large, said second obtaining portion again obtains said tag identification information with a power value lower than said fifth power value, based on control by said power control portion, and in a case where said number of pieces of said tag identification information that said second obtaining portion has obtained with said fifth power value is relatively small, said second obtaining portion again obtains said tag identification information with a power value higher than said fifth power value, based on control by said power control portion,
and
in a case where a number of pieces of said tag identification information that said third obtaining portion has obtained with said sixth power value is large, said third obtaining portion again obtains said tag identification information with a power value higher than said sixth power value, based on control by said power control portion, and in a case where said number of pieces of said tag identification information that said third obtaining portion has obtained with said sixth power value is small, said third obtaining portion again obtains said tag identification information with a power value lower than said sixth power value, based on control by said power control portion.

7. The apparatus according to claim 3, wherein:
said apparatus antenna device comprises a movable antenna whose position can be changed, depending on said first power mode or said second power mode of said power control portion,
or
said apparatus antenna device comprises a first antenna and a second antenna that are installed at different positions and can be switched to each other in using, depending on said first power mode or said second power mode of said power control portion.

8. The apparatus according to claim 2, wherein:
in order that said information obtaining portion, after obtaining said tag identification information from one said first RFID tag circuit element with said first power value or said fourth power value of said apparatus antenna device, obtains said tag identification information from another first RFID tag circuit element; said power control portion resets said power value of said apparatus antenna device to a seventh power value that is higher than said first power value or said fourth power value.

9. The apparatus according to claim 8, further comprising:
a notification device that, when said information obtaining portion has obtained said tag identification information from said another first RFID tag circuit element as a result of resetting of said power value of said apparatus antenna device by said power control portion, supplies a corresponding notification to an operator.

10. The apparatus according to claim 8, wherein:
when said information obtaining portion has obtained said tag identification information from said another first RFID tag circuit element with said reset seventh power value, said power control portion performs control such that said third power value or said fifth power value becomes lower than said seventh power value.

11. A system for article management, comprising:
a third RFID tag circuit element that has an IC circuit part configured to store information and a tag antenna capable of transmission and reception of information, and is held or accompanied by a person;
a fourth RFID tag circuit element that has an IC circuit part configured to store information and a tag antenna capable of transmission and reception of information, and is disposed on an article;
an apparatus for communicating with an RFID tag capable of radio communication with said third RFID tag circuit element and said fourth RFID tag circuit element; and
a management device having a database arranged to be accessible from said apparatus, wherein
said apparatus comprises:
an apparatus antenna device configured to perform radio communication with said third RFID tag circuit element and said fourth RFID tag circuit element;
a power control portion capable of changing a power value of said antenna device;
an information obtaining portion configured to obtain information via said apparatus antenna device from said third RFID tag circuit element and said fourth RFID tag circuit element, based on said power value controlled by said power control portion; and
an association processing portion configured to perform association processing of tag identification information of said fourth RFID tag circuit element with tag identification information of said third RFID tag circuit element, based on a result of comparison between a power value of said apparatus antenna device when said information obtaining portion has obtained information from said fourth RFID tag circuit element and a power value of said apparatus antenna device when said information obtaining portion has obtained information from said third RFID tag circuit element, wherein
said database stores said identification information of said third RFID tag circuit element and said identification information of said fourth RFID tag circuit element having been subjected to said association processing by said association processing portion, in association with each other, and
said management device identifies a state of taking-out or a state of returning of a corresponding article, by said association in said database between said identification information of said fourth RFID tag circuit element and said identification information of said third RFID tag circuit element.
